(19) United States
(12) Patent Application Publication
(10) Pub. No.: US 2018/0215465 A1
(43) Pub. Date: Aug. 2, 2018

(54) Rotatable thruster aircraft with separate lift thrusters

(71) Applicant: Joseph Raymond Renteria, Beaumont, CA (US)

(72) Inventor: Joseph Raymond Renteria, Beaumont, CA (US)

(21) Appl. No.: 15/884,238

(22) Filed: Jan. 30, 2018

Related U.S. Application Data
(60) Provisional application No. 62/452,781, filed on Jan. 31, 2017.

(51) Int. Cl. B64C 29/00; B64C 25/10; B64C 27/02; B64C 27/26; B64C 27/28

(52) U.S. Cl. CPC B64C 29/0033; B64C 25/10; B64C 27/28; B64C 27/26; B64C 27/02

(57) ABSTRACT

A rotatable thruster aircraft includes a fixed wing; rotatable thruster assemblies, each including first and second thrusters that provide rotation via differential thrust; and vertical lift thrusters, optionally connected via an elongated member; and an aircraft control unit, including a processor, a non-transitory memory, an input/output component, and a power manager that controls specific power applied to the thrusters.

### CROSS-REFERENCE TO RELATED APPLICATIONS

This application claims the benefit of U.S. Provisional Application No. 62/452,781, filed Jan. 31, 2017, which is hereby included herein by reference in its entirety.

### FIELD OF THE INVENTION

The present invention relates generally to the field of propulsion systems for VTOL aircraft, and more particularly to methods and systems for hybrid propulsion aircraft including a set of dedicated vertical lift thrusters and a set of rotatable thruster assemblies, which are able to provide lift during both vertical and horizontal flight.

### BACKGROUND OF THE INVENTION

In the world of aviation there are many different types of VTOL/fixed wing systems. So far, the most successful designs have been tilt rotor craft, which have the advantage of using one propulsion system through all envelopes of flight. The disadvantage of tilt rotors is that they must use propulsion systems which are not optimized for either vertical or horizontal flight. Separate lift and thrust systems have gained a lot of popularity in recent years. These systems have two separate and optimized propulsion systems, one dedicated to vertical flight and the other to horizontal. The drawback here is that one system must carry the other as dead weight when not in use.

As such, considering the foregoing, it may be appreciated that there continues to be a need for novel and improved devices and methods for tilt rotor aircrafts.

### SUMMARY OF THE INVENTION

The foregoing needs are met, to a great extent, by the present invention, wherein in aspects of this invention, enhancements are provided to the existing model of tilt rotor aircrafts.

In an aspect, a rotatable thruster aircraft can include:

a) at least one fixed wing; and

b) a right rotatable thruster assembly, including:
a right rotatable structure, which is rotatably connected to the fixed wing on a right side of a longitudinal axis of the rotatable thruster aircraft;
a first right thruster, which is connected to the right rotatable structure on a first side of an axis of rotation of the right rotatable structure; and
a second right thruster, which is connected to the right rotatable structure on a second side of the axis of rotation of the right rotatable structure;
such that the right rotatable thruster assembly is rotatable from a right first position providing a first downward vertical thrust to a right second position providing a first rearward horizontal thrust; and

c) a left rotatable thruster assembly, comprising:
a left rotatable structure, which is rotatably connected to the fixed wing on a left side of a longitudinal axis of the rotatable thruster aircraft;
a first left thruster, which is connected to the left rotatable structure on a first side of an axis of rotation of the left rotatable structure; and
a second left thruster, which is connected to the left rotatable structure on a second side of the axis of rotation of the left rotatable structure;
such that the left rotatable thruster assembly is rotatable from a left first position providing a second downward vertical thrust to a left second position providing a second rearward horizontal thrust.

In a related aspect, a rotatable thruster aircraft can be configured such that the right rotatable thruster assembly includes:
a first right thruster, which is connected to the right rotatable structure on a first side of the center of rotation of the right rotatable structure; and
a second right thruster, which is connected to the right rotatable structure on a second side of the center of rotation of the right rotatable structure;
such that the right rotatable thruster assembly is rotatable via application of a first differential thrust of the first and second right thrusters; and

the left thruster assembly includes:
a first left thruster, which is connected to the left rotatable structure on a first side of the center of rotation of the left rotatable structure; and
a second left thruster, which is connected to the left rotatable structure on a second side of the center of rotation of the left rotatable structure;
such that the at least one left rotatable thruster assembly is rotatable via application of a second differential thrust of the first and second left thrusters.

In another related aspect, the rotatable thruster aircraft can be configured such that the right rotatable thruster assembly is connected to a right tip of the at least one fixed wing, and the left rotatable thruster assembly is connected to a left tip of the at least one fixed wing.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of an embodiment wherein two thruster assemblies pivot independently, and are connected to the wingtips of a flying wing which is passively stabilized.

FIG. 2A is a perspective view of a wing and tailplane embodiment wherein two thruster assemblies pivot independently, and are connected to the wingtips of the aircraft body which is passively stabilized.

FIG. 2B is a perspective view of the rotatable thruster aircraft of FIG. 2A configured for vertical flight, according to an embodiment of the invention.

FIG. 2C is a perspective view of the rotatable thruster aircraft of FIG. 2A configured for horizontal flight, according to an embodiment of the invention.

FIG. 3 is a perspective view of a flying wing embodiment wherein two thruster assemblies pivot independently, and are connected to the wingtips while the wing itself is stabilized by a front and rear thruster.

FIG. 4 is a perspective view of an unswept flying wing embodiment wherein two thruster assemblies pivot independently, and are connected to the wingtips while the wing itself is stabilized by a front and rear thruster.

FIG. 5 is a perspective view of a wing for VTOL aircraft use wherein two thruster assemblies pivot independently, and are connected to the wingtips while the wing itself is stabilized by a front thrusters and rear thrusters connected to longitudinal booms.

FIG. 6 is a perspective view of a wing and tailplane embodiment wherein two thruster assemblies pivot independently, and are connected to the wingtips while the aircraft itself is stabilized by a front and rear thruster.

FIG. 7 is a perspective view of a conventional, double boom wing and tailplane embodiment wherein two thruster assemblies pivot independently, and are connected to the wingtips while the aircraft is stabilized by front thrusters and rear thrusters.

FIG. 8 is a perspective view of a tandem wing, double boom, wing and tailplane embodiment wherein thruster assemblies pivot independently, and are connected to the wingtips while the aircraft is stabilized and lifted by thrusters connected to longitudinal booms connected to the wings.

FIG. 9 is a perspective view of a manned, double boom, wing and tailplane embodiment wherein two thruster assemblies pivot independently, and are connected to the wingtips while the aircraft is stabilized by front thrusters and rear thrusters.

FIG. 10 is a perspective view of a manned, tandem wing embodiment wherein thruster assemblies pivot independently, and are connected to the wingtips while the aircraft stabilized and lifted by thrusters connected to longitudinal booms connected to the wings.

FIG. 11 is a perspective view of a manned, three surface embodiment wherein thruster assemblies pivot independently, and are connected to the wingtips while the aircraft is stabilized and lifted by thrusters connected to longitudinal booms connected to the wings.

FIG. 12 is a perspective view of a manned, single fuselage embodiment wherein thruster assemblies pivot independently, and are connected to the wingtips while the aircraft is stabilized and lifted by thrusters connected directly to the single fuselage of the aircraft.

FIG. 13 is a perspective view of a manned, triple boom wing and tailplane embodiment wherein two thruster assemblies pivot independently, and are connected to the wingtips while the aircraft itself is stabilized and lifted by thrusters connected to three longitudinal booms connected to the wings.

FIG. 14 is a perspective view of a manned, single fuselage embodiment wherein thruster assemblies are connected to the wings, which extend beyond the nacelles while the aircraft itself is stabilized and lifted by thrusters connected directly to the single fuselage of the aircraft.

FIG. 15 is a perspective view of a manned embodiment, which demonstrates the modularity of the concept in that additional vertical lift thrusters and rotatable thrusters may be added as necessary.

FIG. 16 is a perspective view of an unmanned, three surface embodiment wherein thruster assemblies pivot independently, and are connected to the wingtips while the aircraft is stabilized and lifted by thrusters connected to longitudinal booms connected to the wings.

FIG. 17 is a perspective view of a wing and thruster assembly, wherein the amount of thrusters on the thruster assembly is increased by adding them in a linear, longitudinal arrangement.

FIG. 18 is a perspective view of a longitudinal boom, wherein the thrusters are electrically driven propellers which are feathered in a low drag position.

FIG. 19 is a perspective view of a longitudinal boom, wherein the thrusters are electrically driven three bladed propellers resulting in a more compact system.

FIG. 20 is a perspective view of a thruster assembly, wherein the thrusters are electrically driven propellers with disks that overlap resulting in a more compact system.

FIG. 21 is a perspective view of a thruster assembly, wherein the thrusters are electrically driven propellers where one thruster is centrally located and does not provide positioning control to the nacelle.

FIG. 22 is a perspective view of a single boom embodiment wherein the amount of thrusters on the boom is increased by adding them in a linear, longitudinal arrangement.

FIG. 23 is a perspective view of a rotatable thruster aircraft, according to an embodiment of the invention.

FIG. 24 is a perspective view of a rotatable thruster aircraft, according to an embodiment of the invention.

FIG. 25 is a perspective view of a rotatable thruster aircraft, according to an embodiment of the invention.

FIG. 26A is a perspective view of a rotatable thruster aircraft, according to an embodiment of the invention.

FIG. 26B is a perspective view of a rotatable thruster assembly, according to an embodiment of the invention.

FIG. 27 is a perspective view of a rotatable thruster aircraft, according to an embodiment of the invention.

FIG. 28 is a schematic diagram illustrating a rotatable thruster system, according to an embodiment of the invention.

FIG. 29 is a schematic diagram illustrating an aircraft control unit, according to an embodiment of the invention.

FIG. 30 is a side view of a rotatable thruster assembly, according to an embodiment of the invention.

FIG. 31 is a side view of a rotatable thruster assembly in a vertical flight orientation, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

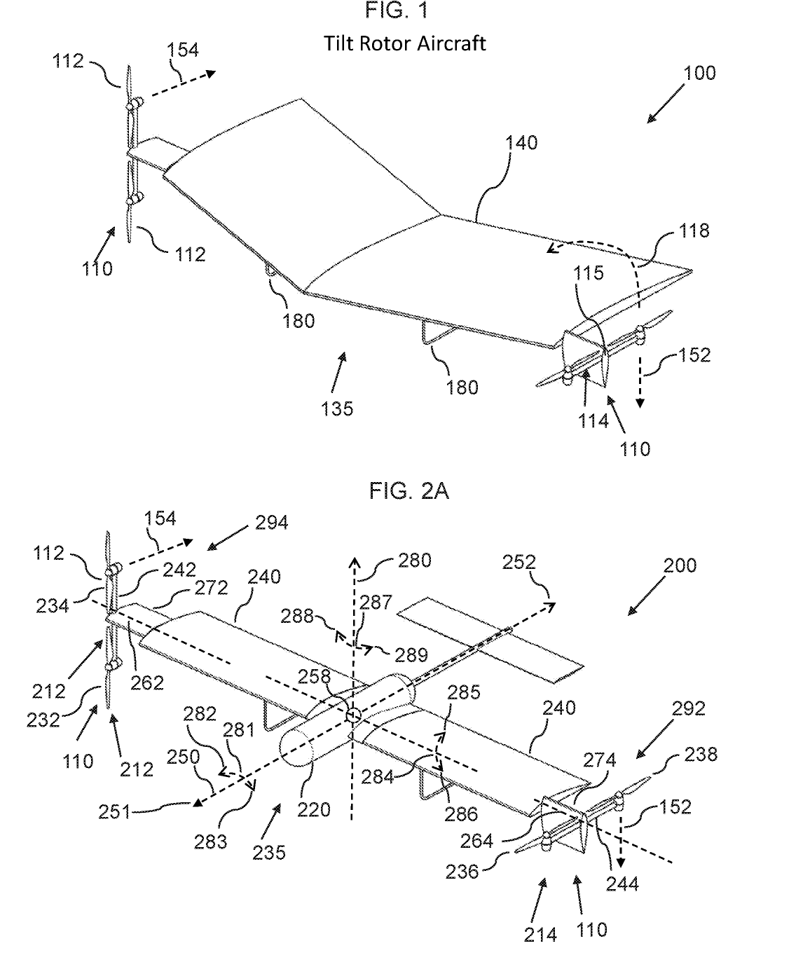

In the following, we describe the structure of an embodiment of a rotatable thruster aircraft 100 with reference to FIG. 1, in such manner that like reference numerals refer to like components throughout; a convention that we shall employ for the remainder of this specification.

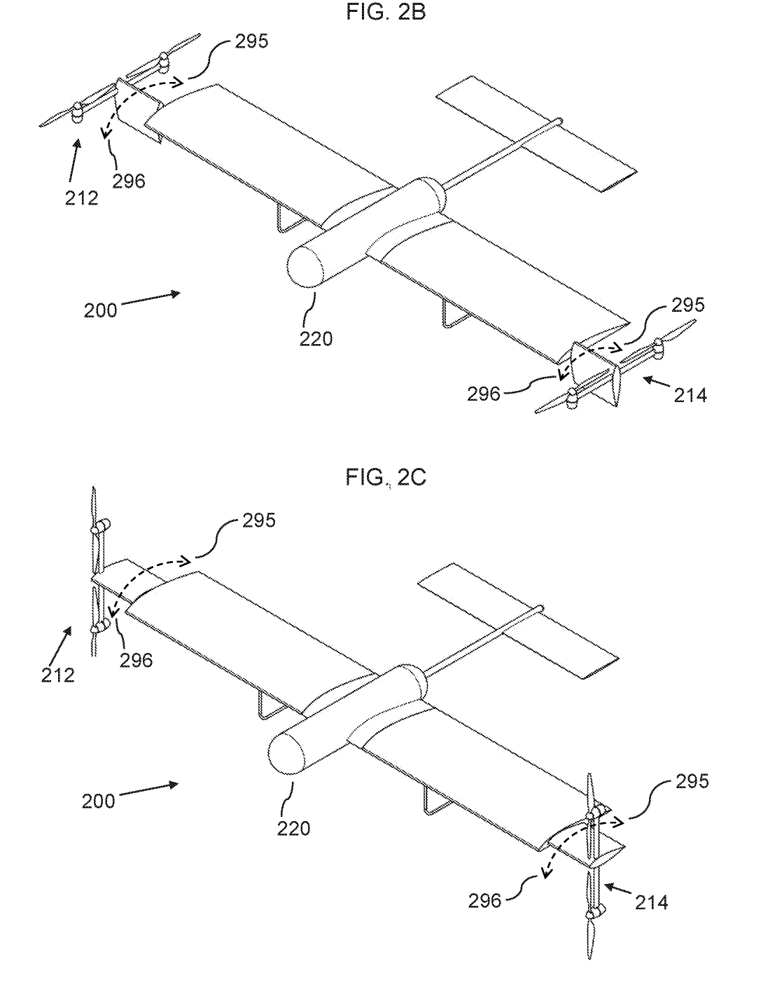

In a related embodiment, a rotatable thruster aircraft 100 includes a tilt rotor system utilizing at least one wing 140 and two or more independently rotatable thruster assemblies 110. In a simple embodiment, the thruster assemblies 110 are comprised of a rotatable structure 114 and multiple thrusters 112 distributed across the pivot point 115 of the thruster assembly, allowing the thrusters 112 to position the thruster assemblies 110 through differential thrust, such that the thruster assemblies 110 can rotate 118 to a preferred orientation, which for example can be either configured for vertical thrust 152 or horizontal thrust 154, or a combination thereof. In a simple embodiment, the thruster assemblies 110 can be connected to the tips of the wing 140, which serves as the main body of the aircraft 100 in the form of a flying wing 100 or the wing may have a connected canard or empennage. In such a simple embodiment, the wing 140 and any connected fuselages 220 (shown in FIG. 2A), stabilizers or other structures is stabilized passively by gravity and/or any relative wind. In the simple embodiment where the airframe is passively stabilized, wheeled landing gear or skids may be attached to any canards, empennages or other structures to accommodate various landing positions.

In various embodiments, the rotatable thruster aircraft 100 implements a tilt thruster/rotor system, which may also take advantage of dedicated vertical lift propulsion, such that it is possible to create a VTOL that uses all available thrust during vertical takeoff with the option of reducing the amount of dead weight carried by the aircraft during horizontal flight. Furthermore, the various embodiments of the present invention are able to accomplish this without using any actuators, with an absolute minimum of moving parts and at the same time provide the option of propulsion redundancy to improve reliability and safety. Finally, this system may be integrated into an aircraft without the need for heavy structural reinforcement, since vertical lift stresses may be distributed along the span of the aircraft.

In various embodiments, a rotatable thruster aircraft 100, which can also be referred to as a rotatable thruster vehicle 100, a tilt thruster aircraft 100, or a tilt thruster vehicle 100, can include all types of flying devices 100, including airplanes 100, and remote-controlled drones 100, but in some embodiments can include other types of vehicles 100, that may benefit from rotatable thruster assemblies 110, such as for example remote-controlled power boats 100, cars 100, submersibles 100, such as a drone submarine, etc. Various other embodiments can include flying devices that may benefit from having rotatable thruster assemblies 110, such as novelty flying devices, including flying fish, arrows, hoverboards and other unique configurations.

In related embodiments, the rotatable thruster aircraft 100 can be configured with landing gear 180, landing legs 180, or other type of devices 180 to allow the aircraft 100 to be stably landed or stably positioned on a ground surface.

In related embodiments, the thrusters 112 can be turbines, propellers, or rotors, or other forms of propulsion mechanisms that generates thrust.

In related embodiments, the thrusters 112 may be powered by electric power, such that each thruster includes an electric engine, which receives electric power from at least one electric power source, such as a battery. However, in alternative embodiments, mechanical power may be transferred to each thruster, via axles, chain, or belt mechanical transfer, from at least one engine, such as an electrical or combustion engine.

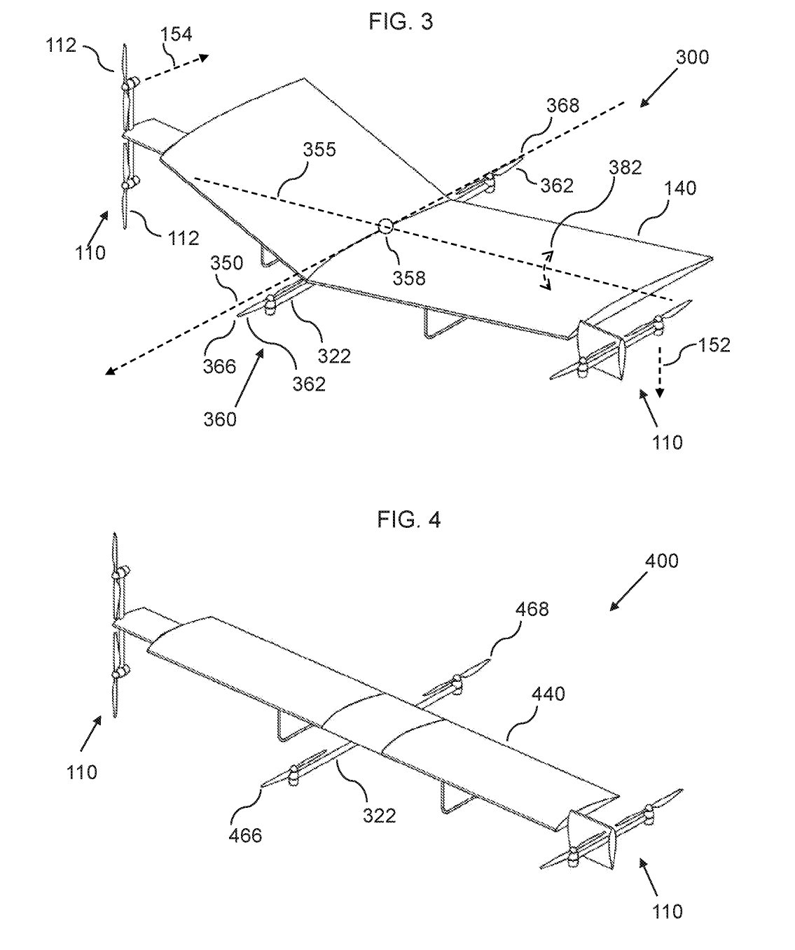

A related embodiment can, for example as shown in FIGS. 3 and 4 further include a dedicated set of vertical lift thrusters 362, which are connected to the airframe, preferably through being mounted to longitudinal booms 322 or fuselages 322, also referred to as elongated members 322, which are then attached to the said at least one wing 240. In this embodiment, the said dedicated vertical lift thrusters 362 provide thrust for vertical flight to the aircraft 300 while the said rotatable thruster assemblies 110 or nacelles 110 are able to provide thrust for both vertical and horizontal flight. In such an embodiment, one or more longitudinal or fuselage components 322 provide a structure onto which at least one front and at least one rear thruster may be mounted. Usually the said longitudinal components 322 will be mounted to one or more wings 140 of the aircraft, with said thrusters 362 mounted to the leading and trailing ends of each longitudinal component 322 where the thrusters 362 may provide vertical lift and control during vertical flight. At least one rotatable thruster assembly 110 is mounted to each the left and right lateral sides of the aircraft. In the preferred embodiment, the rotatable thruster assemblies are placed along the span of the wings, preferably at each wing tip. Each thruster assembly 110 provides thrust during vertical flight, then rotates to provide thrust during horizontal flight as well. Each thruster assembly 110 is comprised of a rotatable structure 114 and at least one thrust producing device. Each thruster assembly 110 has a pivot point. In the preferred embodiment, at least one thruster 112 is placed on each opposing side of the pivot point 115 of a nacelle/rotatable structure 114 in such a way that they may collectively produce a thrust vector 154 while also controlling the position of the nacelle/rotatable structure 114 through differential thrust.

In a related embodiment, thruster assemblies 110 may take the form of a section of the wing, providing lift during forward flight. By rotating the nacelles 114, the wing section may provide lift and also act as a control surface during horizontal flight. This may eliminate the need for additional control surfaces and actuators.

In other related embodiments, thrusters may be any variety of thrust producing device. In such an embodiment, thrusters 112 can include electric motors and propellers, which are sped up or slowed down by a flight control computer to provide stability control. Vertical lift thrusters 362 and rotatable thruster assemblies 110 may work together to provide propulsion and stability during all flight modes. Thrusters 362 which are dedicated to vertical lift may be optimized for static thrust and may be less powerful than standard SLT systems, since they are assisted by the rotatable thrusters 110, saving energy and weight. Rotatable thrusters 110 may be optimized for dynamic thrust and may be less powerful than would be required by a conventional tilt rotor only system, since they will be assisted by the dedicated vertical lift thrusters 362 during vertical takeoff and landing (VTOL), saving weight and increasing efficiency during forward flight. One beneficial feature of the described hybrid SLT/tilt rotor system is that there is much opportunity for optimization and redundant propulsion. Some thrusters 112 may be powered down during horizontal flight to save power, a popular concept in the field of electric VTOL flight. Various thrusters 112 can be optimized for specific roles while still being able to contribute to other roles. Coaxial thrusters may be used to provide a compact static thrust propulsion system for vertical lift as well as an efficient dynamic thrust propulsion system during forward flight.

In various embodiments, thruster assemblies 110 can be standard, actuated structures using a single thruster or differential thrust controlled multi-thruster configurations. The latter option, using differential thrust for rotation, can be beneficial in that it eliminates the weight and complexity of an actuated system, while also lending itself nicely to increased efficiency and redundant propulsion systems, namely multiple electrically powered rotors. Thruster assemblies 110 may be positioned using a variety of positioning sensors. In the preferred embodiment nacelles have their own IMU and are able to position themselves in relation to the horizon and/or the aircraft.

In other various embodiments, wings 140 240 may be in a variety of configurations. In a related embodiment, the wings 140 240 serve as a mounting structure for both the vertical lift thrusters 362 and the rotatable thrusters 110, although thrusters may be mounted to a variety of structures which allow them to be connected to the airframe. In such an embodiment, the vertical lift thruster 362 can be connected to booms 322 which are then longitudinally attached to the wing, similar to what is the common method of attaching motors to conventional SLT systems. The rotatable thruster assemblies 110 can be attached to the wing tips and pivot to provide yaw control during hover and roll and pitch control during horizontal flight. Conventional wing and tailplane and canard configurations as well as tandem wing and triple surface configurations can be used. In tandem and triple wing configurations, it is possible to allow two or more wings/surfaces to share the same longitudinal boom structure 322 to allow the thrusters to be mounted on so that they may lift the aircraft 300 vertically. Because the vertical lift thrusters 362 and the rotatable thrusters 110 can be mounted directly to the wing, they can be distributed along the span of the wing 140 and so divide the stress of lifting the wing along the span of the wing which is very structurally efficient.

In various related embodiments, ideally, aircraft control is provided through differential thrust during all modes of flight to increase simplicity and save weight. However, conventional control surfaces and other methods can also be used. Hybrid fuel/electric systems can also be used, for example, the vertical lift thrusters 362 can be shaft driven by a turbine or other engine, while the rotatable thruster 110 can be electrically powered, or the turbine or engine can be configured to generate power for the electrically powered thrusters 112. In some embodiments, the VTOL aircraft 100 can be equipped with landing gear, which enables the aircraft to perform both VTOL and CTOL. Electrically powered, redundant rotors 112 can used for the rotatable thrusters, such that some of the rotatable thrusters 112 can be shut down during horizontal flight and they may use foldable props to reduce drag. The described methods may be used to enable VTOL for a manned or unmanned aircraft. Fairing or shrouding may be utilized to provide enhanced aerodynamics to vertical lift systems when not in use. Folding propellers may also be utilized for vertical lift thrusters, allowing the propeller blades to passively swing rearward when not in use during horizontal flight. Thruster assemblies 110 may be positioned by actuators, springs, magnets, pendulum effect or other methods when not in use. They may also be axially connected to an airframe by brushless or stepper motors for positioning purposes. During forward flight, thruster assemblies may be held in place using a large variety of mechanical and electromechanical methods, enabling complete thruster assemblies stability and allowing rotors to be powered off while maintaining horizontal flight nacelle positioning.

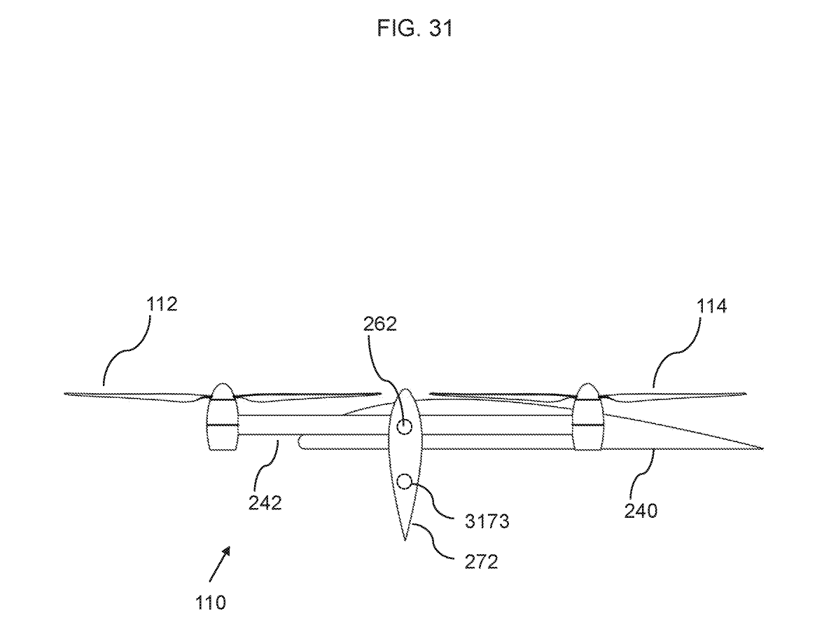

In a related embodiment, as shown in FIG. 31, a rotatable thruster assembly 110 can be configured to passively rotate to be positioned for vertical take-off, when not in use. In a further related embodiment, the rotatable thruster assembly 110 can be configured with a center of mass 3173 that is offset from the axis of rotation 262 of the rotatable thruster assembly 110, such that the rotatable thruster assembly 110 is in a vertical take-off position, when the rotatable thruster assembly 110 is rotated by gravity to a position with the center of mass 3173 in a lowest position, as shown in FIG. 31. As shown, the center of mass can be configured in the rotatable winglet 272, but can also be configured in other parts of the rotatable thruster assembly 110. In alternative embodiments, the passive rotation to a neutral position for vertical takeoff can for example be implemented via use of springs, magnets, or other related gravity/pendulum configurations.

In another related embodiment, while each wing 140 on an aircraft 100 provides an ideal structure for vertical lift and rotatable thruster mounting, it is not a requirement. For example, a wing may have no thrusters at all, or it may have only vertical lift or only rotatable thrusters or both.

In yet another related embodiment, it is also possible to create a configuration using only one or more pivotable/rotatable thruster assemblies 110, where the one or more thruster assemblies 110 are centrally located adjacent to the center of gravity of the aircraft, which is then stabilized by dedicated vertical lift thrusters 362.

In an embodiment, in reference to FIG. 1, one embodiment resembles and functions as a flying wing 140 with a thruster assembly 110 attached to each wingtip. Each thruster assembly 110 has multiple thrusters 112 distributed across the pivot point 115 of the thruster assembly, which collectively produce a thrust vector 154 while also controlling the position of the thruster assembly 110. Each thruster assembly 110 contains a positioning sensor and pivots independently from the other nacelle and of the aircraft. The main body 140 of the aircraft, is passively stabilized and is affected by gravity and any relative wind.

In a related embodiment, as shown in FIG. 2A, a rotatable thruster aircraft 200 can include a conventional wing and tailplane configuration, with a thruster assembly 110 attached to each wingtip. Each thruster assembly 110 has multiple thrusters 112 distributed across the pivot point 115 of the thruster assembly, which collectively produces a thrust vector 154 while also controlling the position of the thruster assembly 110. Each thruster assembly 110 contains a positioning sensor and pivots independently from the other thruster assembly 110 and of the aircraft. The main body 220 of the aircraft is passively stabilized and is affected by gravity and any relative wind.

In a related embodiment, as shown in FIG. 3, a rotatable thruster aircraft 300 can be configured as a swept flying wing 300 with a thruster assembly 110 attached to each wingtip. Each thruster assembly has multiple thrusters 112 distributed across the pivot point 115 of the thruster assembly, which collectively produce a thrust vector 154 while also controlling the position of the thruster assembly. Each thruster assembly contains a positioning sensor and pivots independently from the other thruster assembly. The main body of the aircraft is stabilized by one or more front thrusters and one or more rear thrusters.

In a related embodiment, as shown in FIG. 4, a rotatable thruster aircraft 400 can be configured with an unswept flying wing 440 with a thruster assembly 110 attached to each wingtip. Each thruster assembly 110 has multiple thrusters 112 distributed across the pivot point 115 of the thruster assembly 110, which collectively produce a thrust vector 154 while also controlling the position of the thruster assembly 110. Each thruster assembly 110 contains a positioning sensor and pivots independently from the other thruster assembly. The main body 440 of the aircraft 400 is stabilized by one or more front vertical thrusters 466 and one or more rear vertical thrusters 468.

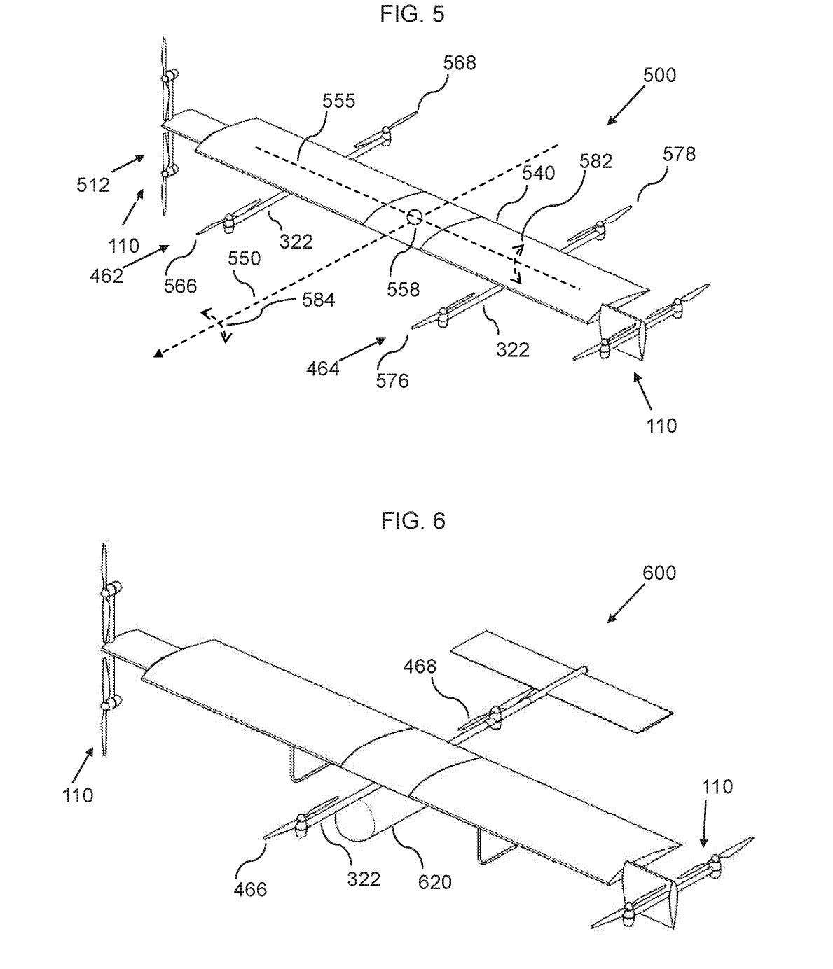

In a related embodiment, as shown in FIG. 5, a rotatable thruster aircraft 500 can be configured with a wing 540 with a rotatable thruster assembly 110 connected to each wingtip and one or more longitudinal boom/fuselage components 322 connected to the wing enabling at least one front vertical lift thruster 466 and at least one rear vertical lift thruster 468 to be connected to the airframe 540.

In a related embodiment, as shown in FIG. 6, a rotatable thruster aircraft 600 can be configured as a conventional wing and tailplane airframe, with a rotatable thruster assembly 110 attached to each wingtip. One or more front thrusters 466 and one or more rear thrusters 468 are attached directly to the single fuselage 620 to provide vertical lift and pitch stability during vertical flight.

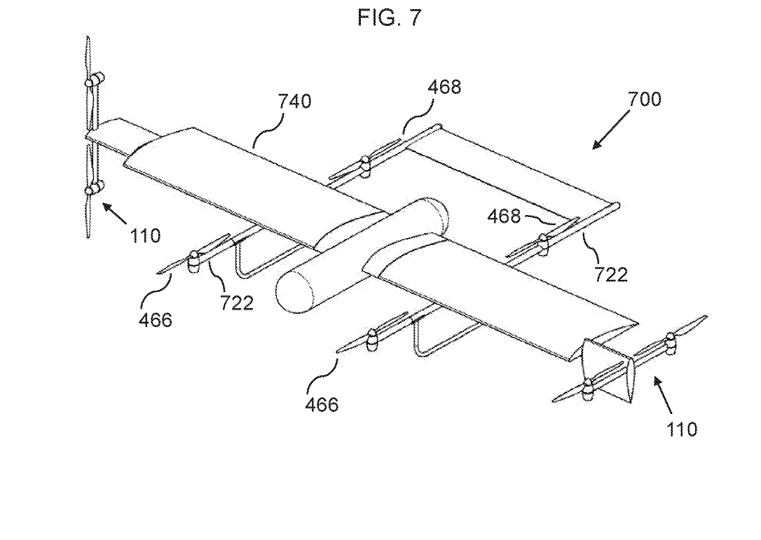

In a related embodiment, as shown in FIG. 7, a rotatable thruster aircraft 700 can be configured with a double boom wing 740 and tailplane airframe, with a rotatable thruster assembly 110 attached to each wingtip. One or more front thrusters 466 and one or more rear thrusters 468 can be attached to the double booms 722 to provide vertical lift and pitch and roll stability during vertical flight.

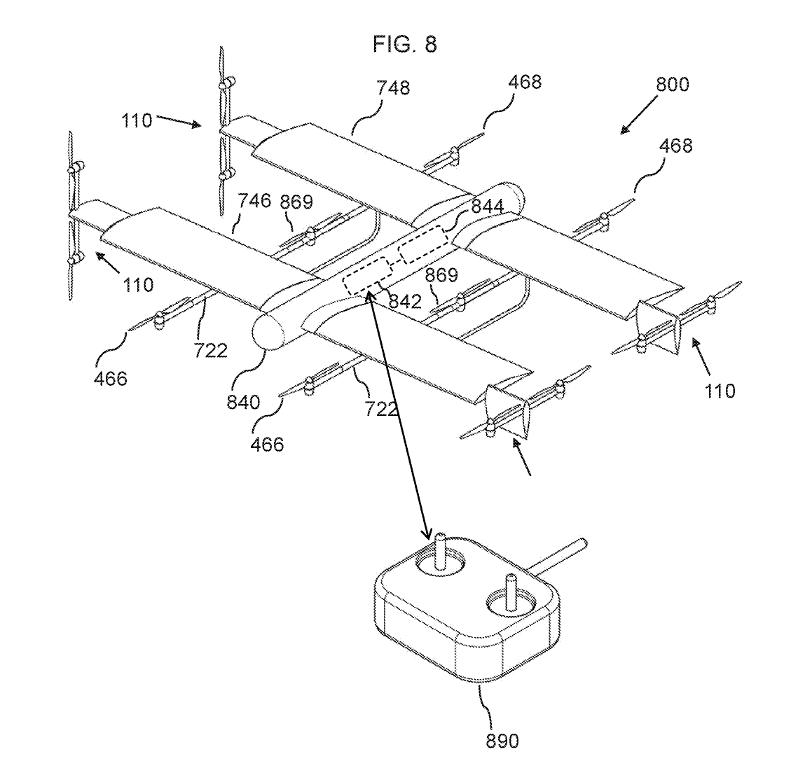

In a related embodiment, as shown in FIG. 8, a rotatable thruster aircraft 800 can be configured with a tandem wing 746 748 airframe, with a rotatable thruster assembly 110 attached to each wingtip. One or more front thrusters 466 and one or more rear thrusters 468 are attached to the double booms 722 to provide vertical lift and pitch and roll stability during vertical flight. Additionally, central vertical lift thrusters 869 are connected to double boom components which are shared by the front wing and the rear wing.

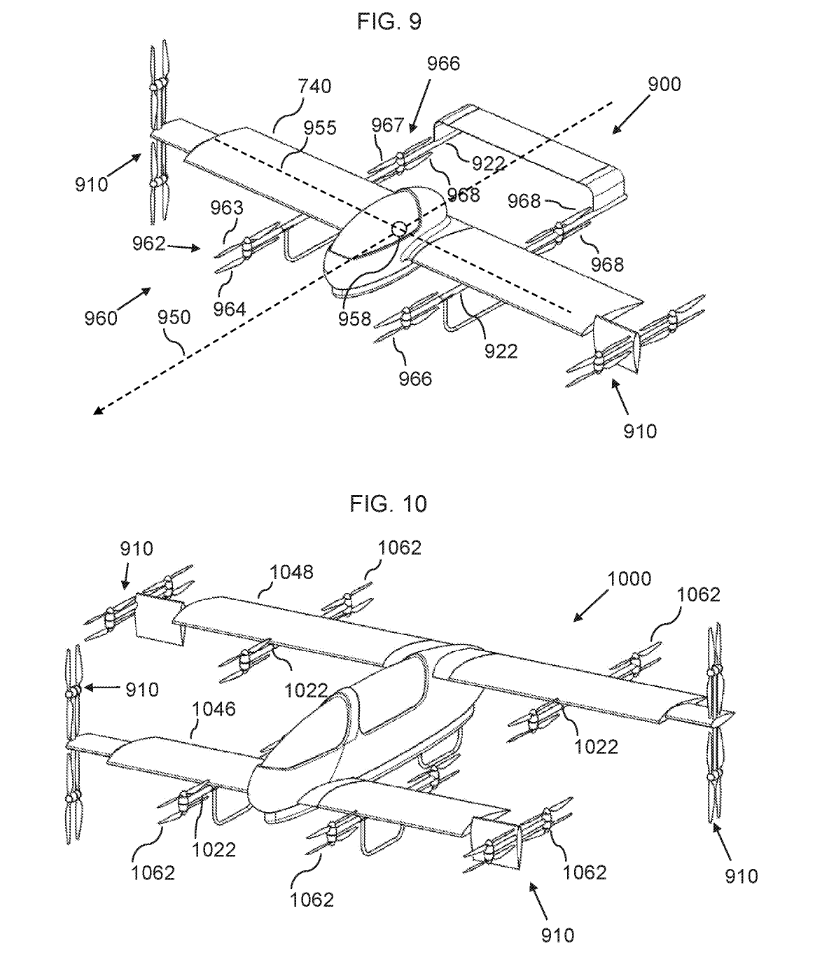

In a related embodiment, as shown in FIG. 9, a manned rotatable thruster aircraft 900 can be configured as a double boom wing and tailplane airframe, with a rotatable thruster assembly 910 attached to each wingtip. One or more front thrusters 963 964 and one or more rear thrusters 967 968 can be attached to the double booms 922 to provide vertical lift and pitch and roll stability during vertical flight.

In a related embodiment, as shown in FIG. 10, a manned rotatable thruster aircraft 1000 can be configured with a tandem wing 1046 1048 airframe, with a rotatable thruster assembly 910 attached to each wingtip. One or more thrusters 1062 can be attached to longitudinal booms 1022 attached to each wing to provide vertical lift and pitch and roll stability during vertical flight.

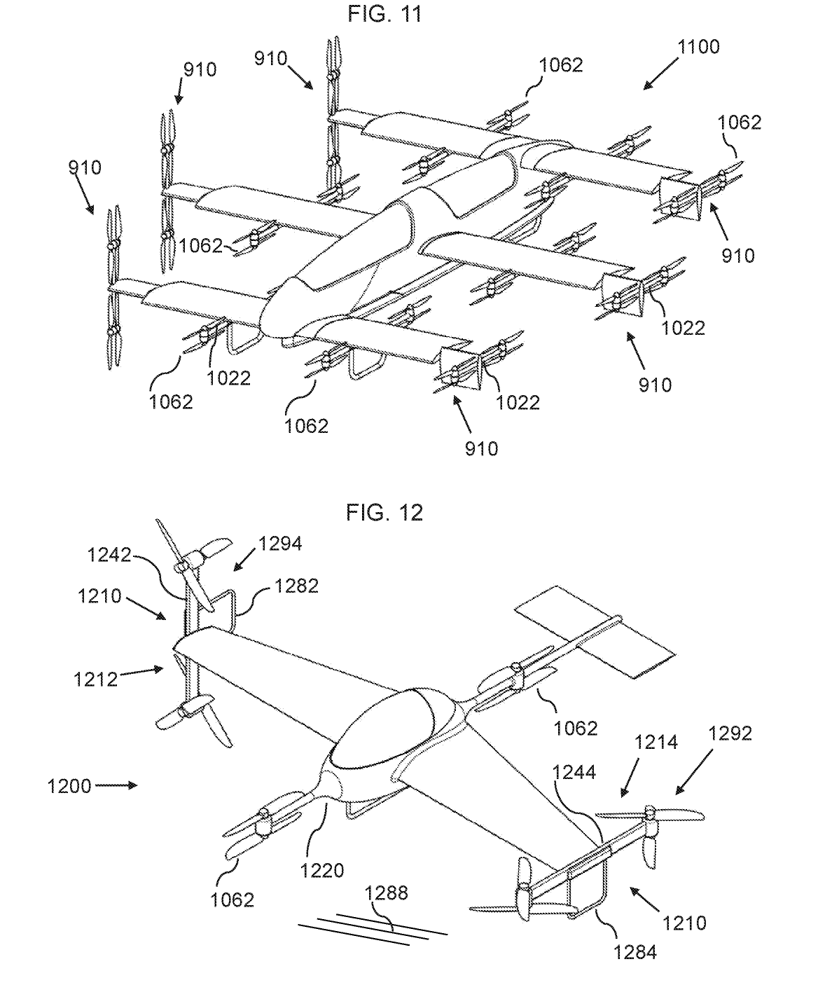

In a related embodiment, as shown in FIG. 11, a manned rotatable thruster aircraft 1100 can be configured with a three-surface airframe, with a rotatable thruster assembly 910 attached to each wingtip. One or more thrusters 1062 can be attached to longitudinal booms 1022 attached to each wing to provide vertical lift and pitch and roll stability during vertical flight.

In a related embodiment, as shown in FIG. 12, a manned rotatable thruster aircraft 1200 can be configured as a conventional wing and tailplane airframe, with a rotatable thruster assembly 1210 attached to each wingtip, such that one or more thrusters 1062 can be attached directly to the single, main fuselage 1220 to provide lift and pitch stability during vertical flight.

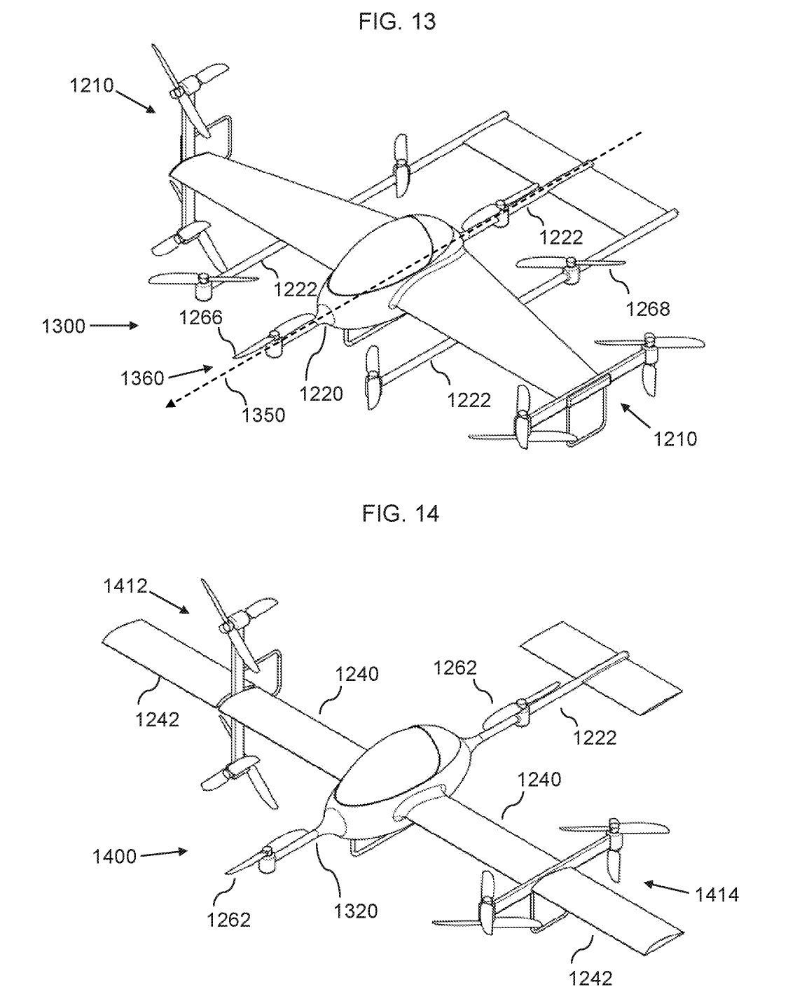

In a related embodiment, as shown in FIG. 13, a manned rotatable thruster aircraft 1300 can be configured as a triple boom 1222 wing and tailplane airframe, with a rotatable thruster 1210 assembly attached to each wingtip. One or more front thrusters 1266 and one or more rear thrusters 1268 can be attached to the triple booms to provide vertical lift and pitch and roll stability during vertical flight.

In a related embodiment, as shown in FIG. 14, a manned rotatable thruster aircraft 1400 can be configured as a conventional wing and tailplane airframe, with a rotatable thruster assembly 1412 1414 attached along the span of each wing, such that each wing extends beyond the rotatable thruster assembly. One or more thrusters 1262 can be attached directly to the single, main fuselage 1320 to provide lift and pitch stability during vertical flight.

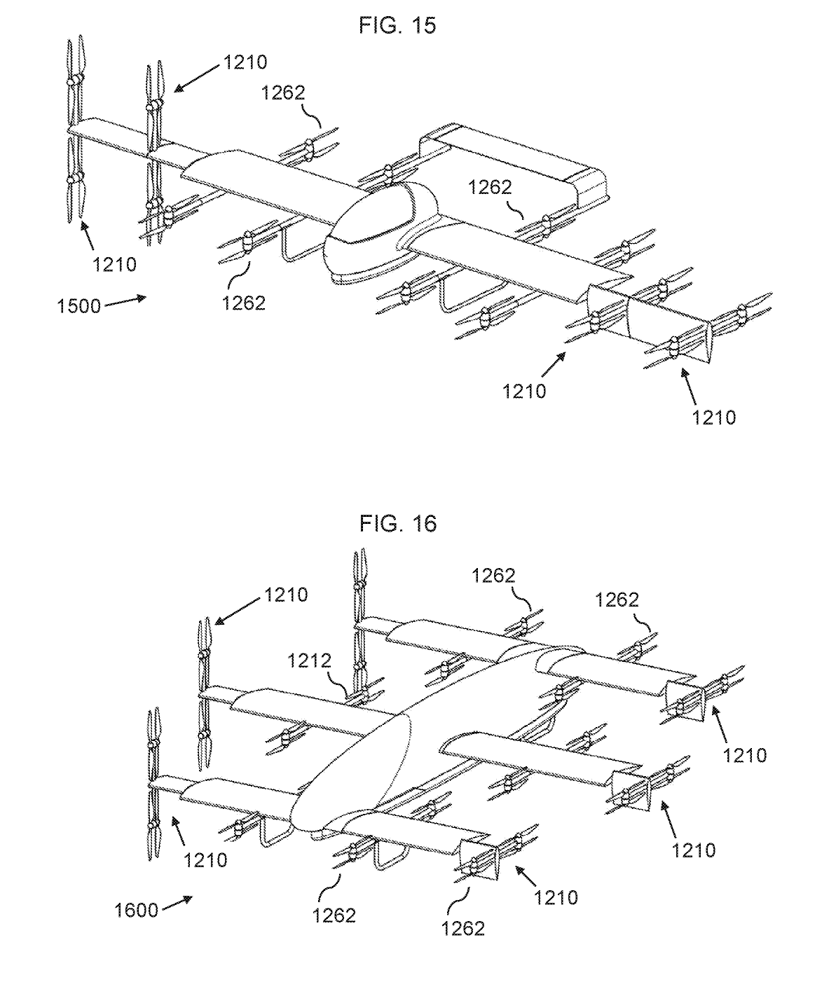

In a related embodiment, as shown in FIG. 15, vertical thrusters 1262 can be modularly added as necessary. The figure depicts multiple longitudinal booms being laterally added to each wing, as well as rotatable thruster assemblies 1210 with a laterally expanded number of thrusters.

In a related embodiment, as shown in FIG. 16, a manned rotatable thruster aircraft 1600 can be configured as a three-surface airframe, with a rotatable thruster assembly 1210 attached to each wingtip. One or more fixed vertical thrusters 1262 can be attached to longitudinal booms attached to each wing to provide vertical lift and pitch and roll stability during vertical flight.

In a related embodiment, as shown in FIG. 17, vertical lift thrusters 1762 can be modularly added as necessary. The figure depicts a rotatable thruster assembly 1710 with an expanded number of thrusters 112 added in a linear and longitudinal manner.

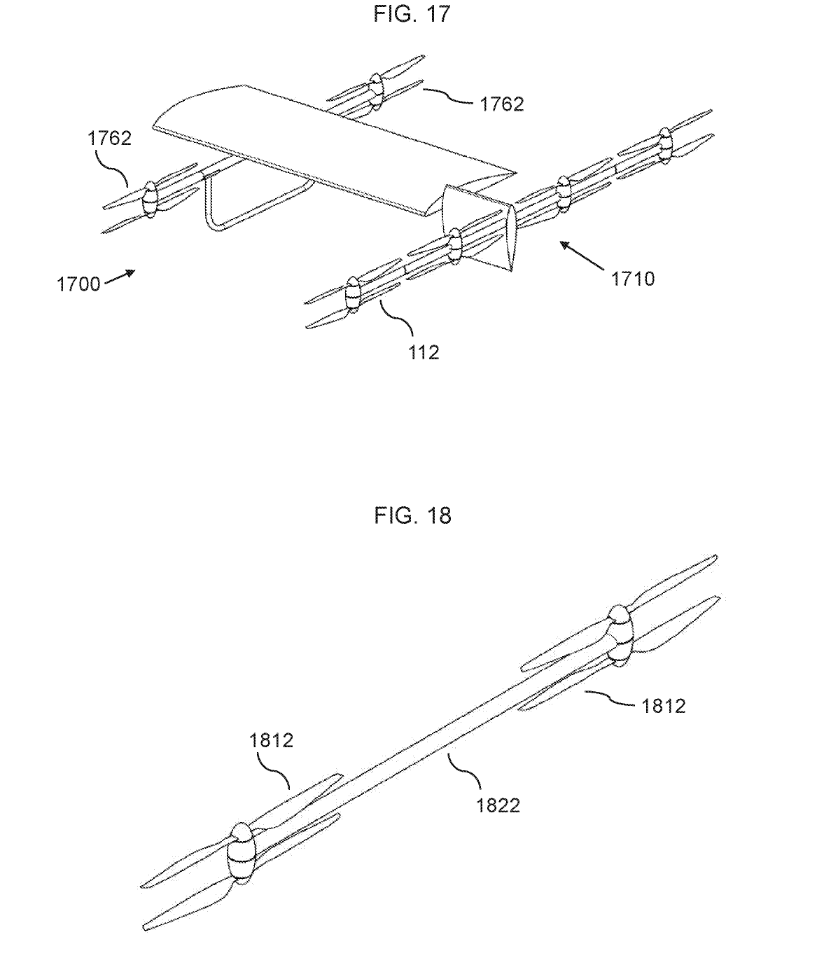

In a related embodiment, FIG. 18 depicts a core component of the dedicated vertical lift system and rotatable thruster assemblies, a boom 1822 with multiple opposite vertical thrusters 1812 mounted to it. This results in a lightweight, strong and compact thruster configuration which can be feathered for low drag when not in use as depicted in the drawing.

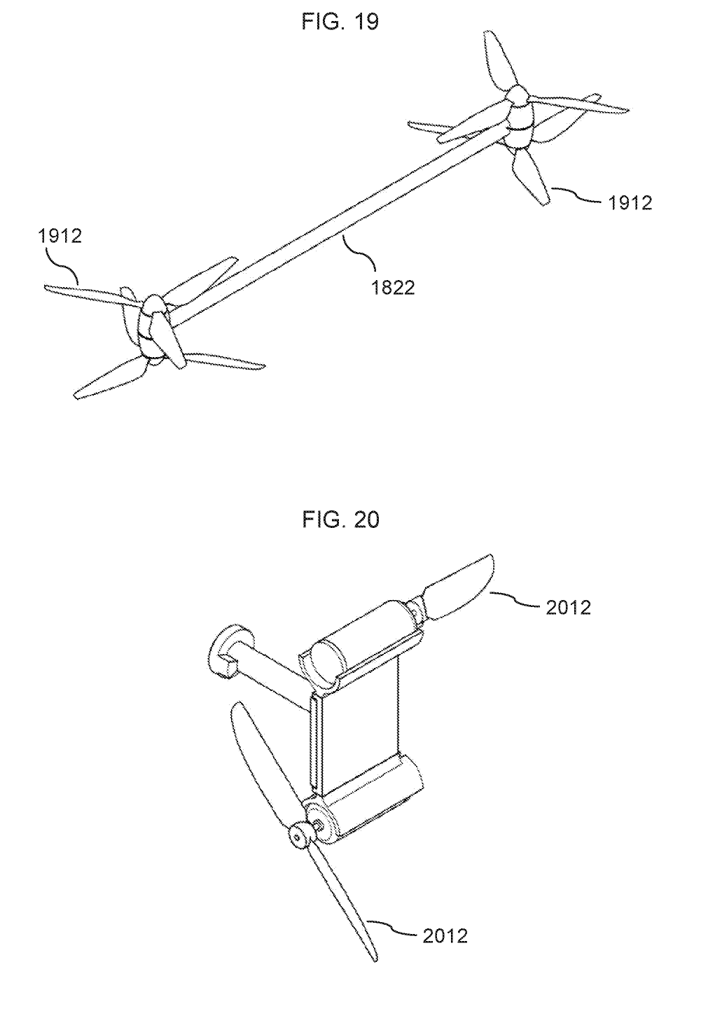

In a related embodiment, FIG. 19 depicts a core component of the dedicated vertical lift system and rotatable thruster assemblies, a boom 1822 with multiple opposite vertical thrusters 1912 mounted to it. This results in a lightweight, strong and compact thruster configuration. As shown, the thrusters 1912 can be three bladed and electrically powered propellers, which creates a compact thruster assembly.

In a related embodiment, as shown in FIG. 20, thrusters 2012 can be electrically driven propellers. Propeller disks can be arranged to overlap resulting in a very compact, differential thrust controlled, rotatable thruster assembly.

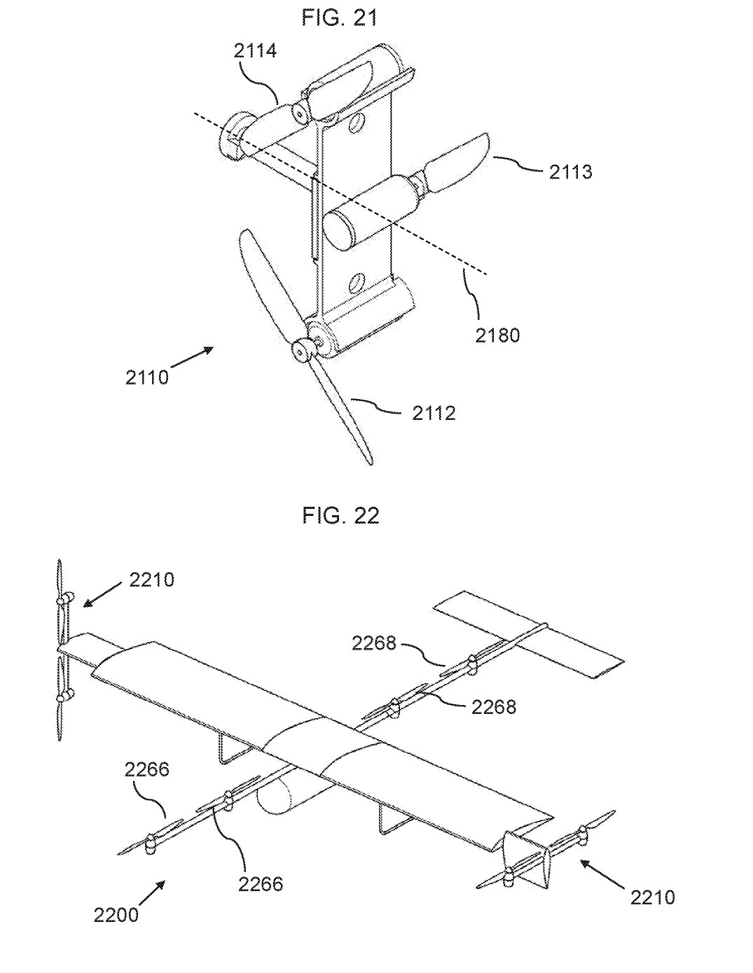

In a related embodiment, as shown in FIG. 21, thrusters can be electrically driven propellers. Thrusters can be arranged so that not all thrusters 2112 2113 2114 contribute to thruster assembly position control. In the depicted thruster assembly, the central thruster 2113 provides thrust, but not thruster assembly control, whereas the thrusters 2112 2114 provide rotational control of the rotatable thruster assembly 2110.

In a related embodiment, as shown in FIG. 22, a rotatable thruster aircraft 2200 can be configured as a conventional wing and tailplane airframe, with a rotatable thruster assembly 2210 attached to each wingtip. One or more front vertical thrusters 2266 and one or more rear vertical thrusters 2268 can be attached directly to the single fuselage to provide vertical lift and pitch stability during vertical flight. The amount of dedicated vertical lift thrusters can be expanded by linearly adding front and rear thrusters.

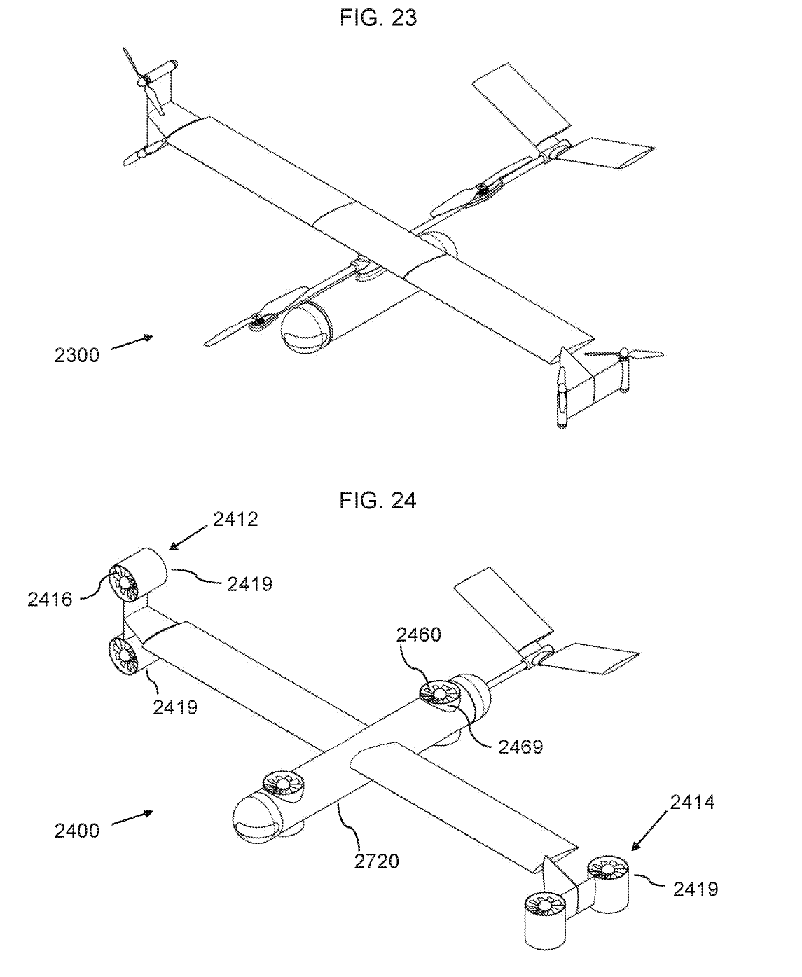

FIG. 23 depicts an embodiment with an alternative design of a rotatable thruster aircraft 2300.

In a related embodiment, as shown in FIG. 24, a rotatable thruster aircraft 2400 can be configured with ducted/shrouded turbine fans or rotors.

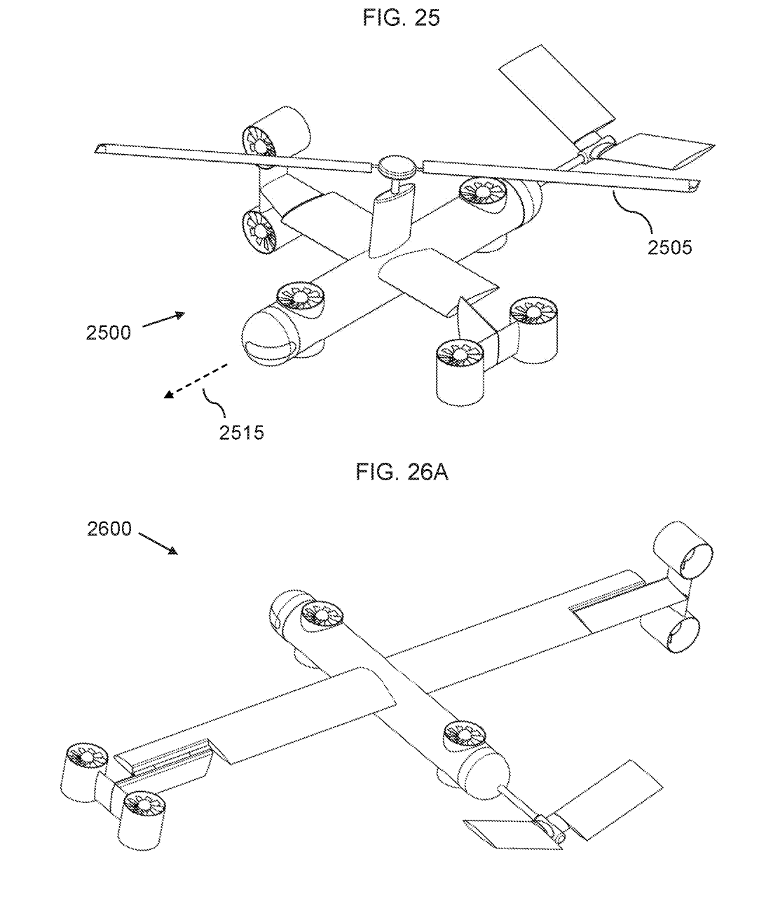

In a related embodiment, as shown in FIG. 25, a rotatable thruster aircraft 2500 can further include at least one unpowered rotor 2505, which is configured to rotate and provide lift during forward flight, such that the rotatable thruster aircraft 2500 can be configured as an autogyro/gyrocopter.

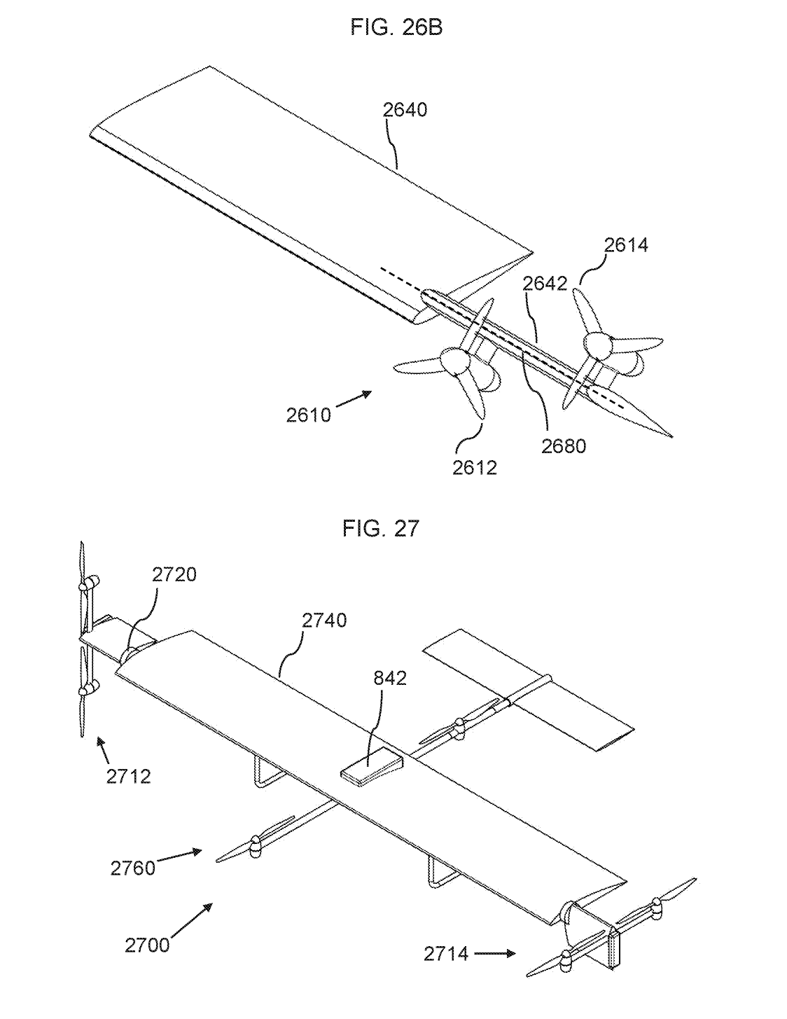

In a related embodiment, as shown in FIG. 26A, a rotatable thruster aircraft 2600 can be configured with a pivoting section of wing which is attached to the wing by a span-wise hinge and also acts as a control surface, which forms a very strong and lightweight pivoting mechanism.

In a related embodiment, as shown in FIG. 26B, a pivoting section of wing 2642 can be rotationally attached to a main wing segment 2640, and also acts as a control surface, such that the pivoting section of wing 2642 is as a rotatable structure 2642 of a rotatable thruster assembly 2610, to which first and second thrusters 2612 2614 are attached in a staggered fashion, such that the first thruster 2612 is mounted on an inside of the second thruster 2614, such that the first and second thrusters 2612 2614 overlap vertically, such that the such that the first and second thrusters thrusters 2612 2614 can be mounted closer to the rotational axis 2680, thereby significantly reducing drag of the rotatable thruster aircraft.

In a related embodiment, as shown in FIGS. 8, 17, and 27, the rotatable thruster aircraft 800 1700 2700 can further include an aircraft control unit 842, which is mounted in the aircraft body/fuselage 840, for example in a main body 840, wherein the aircraft control unit 842 is configured to control a specific power applied for each thruster 112 in a rotatable thruster assembly 210.

In a further related embodiment, as shown in FIGS. 8 and 27, the rotatable thruster aircraft 800 2700 can be configured to communicate, via the aircraft control unit 842 with a remote control device 890, such that a user 2820 can use the remote control device 890 to control the rotatable thruster aircraft 1700.

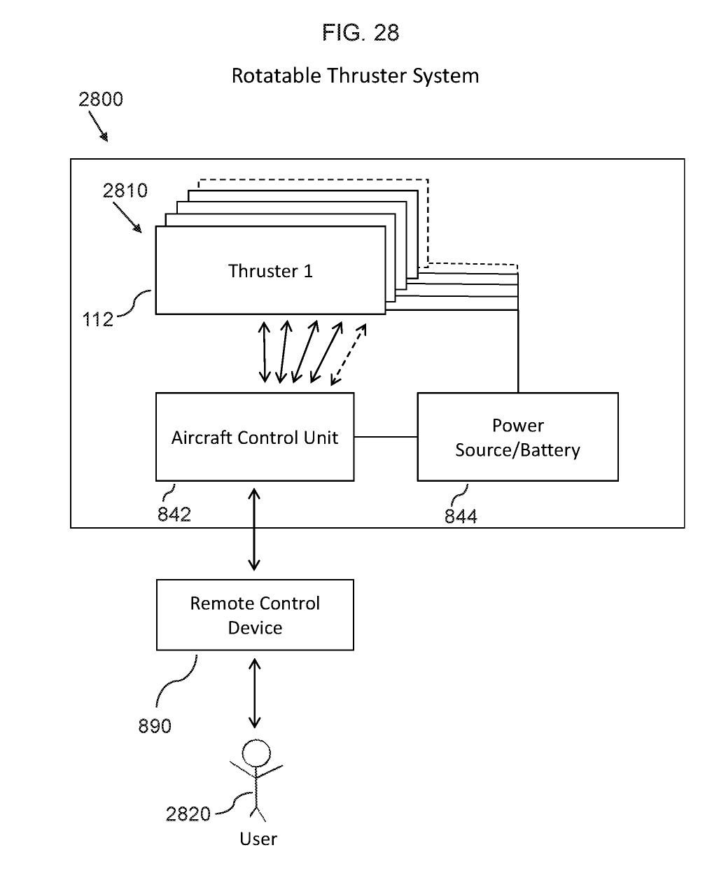

In an embodiment, as shown in FIG. 28, a tilt rotor system 2800 can include:
a) a plurality of rotatable thruster assemblies 2810, including a plurality of thrusters 112;
b) a power source 844, such as a battery 844; and
c) an aircraft control unit 842, which can be mounted in a main body of the aircraft 2700;
wherein the aircraft control unit 842 is configured to control a specific power applied for each thruster 112 in the plurality of thrusters 112, wherein the specific power applied for each thruster is provided by the power source 844.

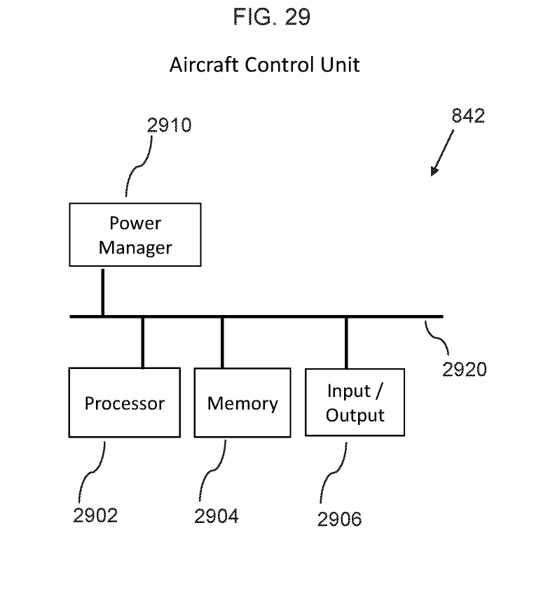

In a related embodiment, as shown in FIG. 29 the aircraft control unit 842 can further include:
a) a processor 2902;
b) a non-transitory memory 2904;
c) an input/output component 2906; and
d) a power manager 2910 (that can also be referred to as a flight manager 2910), which is configured to control the specific power applied for each thruster 112 in the right and left rotatable thruster assemblies 2712 2714; all connected via
e) a data bus 2920.

In related embodiments, the flight manager 2910 can execute flight control software that is loaded into memory 2904, and the aircraft control unit 842 can further include (or communicate with) flight control/avionic systems/components such as accelerometers, gyros, barometer, GPS, etc. As shown in FIG. 27, the rotatable thruster aircraft 2700 can further include rotary position sensors, such as hall effect sensors to determine the position the nacelles, which can be positioned between the wings and rotatable thruster assemblies 2712 2714. The rotatable thruster assemblies 2712 2714 can further include inertial measurement unit (IMU) sensors 2720 for determining the position of the rotatable thruster assemblies 2712 2714. The control unit 842 can further include an IMU sensor for determining the position of the main body. The rotatable thruster assemblies 2712 2714 may take commands from the control unit 842, or in the case of a remotely controlled aircraft they may take commands directly from a remote control device 890. Rotary position sensors, or IMUS, or both may be used to determine rotatable thruster assembly 2712 2714 position. In a further related embodiment, the flight manager 2910 can be configured to calculate and control position of the rotatable thruster assembly 2712 and thrust output for each thruster 112 in the rotatable thruster assembly 2712, via an IMU/position sensor attached to the main body 2740 of the aircraft 2700, eliminating the requirement to have such sensors located within the rotatable thruster assembly 2712 itself.

In a related embodiment, as shown in FIGS. 1, 2A, 2B, 27, and 28, the rotatable thruster aircraft 100 200 2700 can be configured with solely one right rotatable thruster assembly 212 and solely one left rotatable thruster assembly 214, wherein one or more aircraft control units 842 mounted on the main body 220 are configured to determine and control the position of the main body 220, as well as the positions and thrust outputs of the right and left rotatable thruster assemblies 212 214 in relation to the main body 220 during vertical flight 280, as shown in FIG. 2B, such that:
a) a movement around the yaw axis 288 of the main body 220 indicates the positions of the right and left rotatable thruster assemblies 212 214 relative to each other, such that a positive/right yaw 288 indicates that the left rotatable thruster assembly 214 is pitched forward relative to the right rotatable thruster assembly 212, and a negative/left yaw 289 indicates that the right rotatable thruster assembly 212 is pitched forward relative to the left rotatable thruster assembly 214;
b) a movement around the roll axis 281 of the main body 220 indicates the thrust outputs of the right and left rotatable thruster assemblies 212 214 relative to each other, such that a positive/right roll 282 indicates that the left rotatable thruster assembly 214 is producing more thrust relative to the right rotatable thruster assembly 212, and a negative/left roll 283 indicates that the right rotatable thruster assembly is producing more thrust relative to the left rotatable thruster assembly; and
c) a movement along a longitudinal axis 250 of the main body 220 indicates positions of the right and left rotatable thruster assemblies 212 214 in relation to the main body 220, such that a forward motion 251 along the longitudinal axis 250 of the main body 220 indicates that the rotatable thruster assemblies 212 214 are pitched forward 296 in relation to the main body 220, and a rearward motion 252 along the longitudinal axis 251 of the main body 220 indicates that the rotatable thruster assemblies 212 214 are pitched rearward 295 in relation to the main body 220.

In another related embodiment, as shown in FIGS. 1, 2A, 2C, 27, and 28, the rotatable thruster aircraft 100 200 2700 can be configured with solely one right rotatable thruster assembly 212 and solely one left rotatable thruster assembly 214, wherein one or more aircraft control units 842 mounted on the main body 220 are configured to determine and control the position of the main body, as well as the positions and thrust outputs of said right and left rotatable thruster assemblies in relation to the main body during horizontal flight 250, as shown in FIG. 2C, such that:
a) a movement around the yaw axis 280 of the main body 220 indicates the thrust outputs of the right and left rotatable thruster assemblies 212 214 relative to each other, such that a positive/right yaw 288 of the main body 220 indicates that the left rotatable thruster assembly 214 is producing more thrust relative to the right rotatable thruster assembly 212, and a negative/left yaw 289 of the main body 220 indicates that the right rotatable thruster assembly 212 is producing more thrust relative to the left rotatable thruster assembly 214;
b) a movement around the roll axis 281 of the main body 220, indicates positions of the right and left rotatable thruster assemblies 212 214 relative to each other, such that a positive/right roll 282 of the main body 220 indicates that the right rotatable thruster assembly 212 is pitched forward 296 relative to the left rotatable thruster assembly 214, and a negative/left roll 283 of the main body 220 indicates that the left rotatable thruster assembly 214 is pitched forward 296 relative to the right rotatable thruster assembly 212; and
c) a movement around the pitch axis 284 of the main body, indicates the pitch of the right and left rotatable thruster assemblies 212 214 in relation to the main body 220, such that a positive/upward pitch 285 of the main body 220 indicates that the rotatable thruster assemblies 212 214 are pitched rearward 295 in relation to the main body 220, and a negative/downward pitch 285 of the main body 220 indicates that the rotatable thruster assemblies 212 214 are pitched forward 296 in relation to the main body 220.

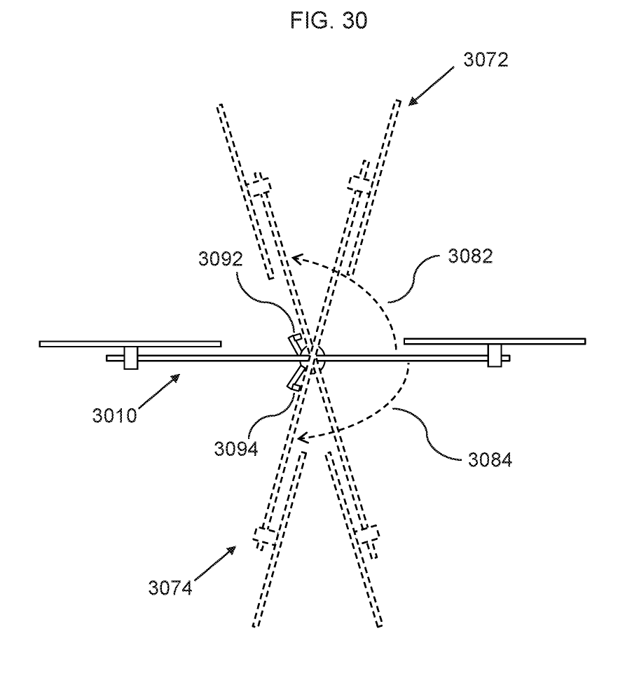

In some embodiments, as shown in FIG. 30, rotation of a rotatable thruster assembly 3010 can be mechanically limited in both directions, such that rotation is stopped by a forward rotational stop member 3092 or rearward rotational stop member 3094, once respectively a maximum forward or rearward rotation position of the rotatable thruster assembly 110 is reached, corresponding to a rearward or forward flight position for the rotatable thruster assembly 110. Here the maximum forward and rearward positions are shown configured to exceed respectively +90 and −90 degrees by approximately 20 degrees to provide additional pitch control capability. Once a forward flight position is reached and the rotatable thruster assembly 110 reaches its mechanical limit of a maximum forward rotation position, as shown in FIG. 2A, the lower thruster 232 may be powered down and/or feathered, leaving the upper thruster 234 to provide thrust and to hold the rotatable thruster assembly 110 position against the mechanical stop.

In a related embodiment, as shown in FIG. 12, the rotatable thruster assembly 3010 can further include:
a) a forward rotational stop member 3092, which is configured to stop a forward rotation 3082 of the rotatable thruster assembly 3010 at a maximum forward rotation position 3072; and
b) a rearward rotational stop member 3094, which is configured to stop a rearward rotation 3084 of the rotatable thruster assembly 3010 at a maximum rearward rotation position 3074.

In some embodiments, vertical lift props may be of a foldable type, such that propeller blades swing out during use, allowing them to passively fold back and feather in the relative wind when not in use.

In some embodiments, the vertical lift thrusters 360 can provide a dominant portion of the vertical lift; but in other embodiments the vertical lift thrusters 360 may serve mainly as stabilizers, leaving the rotatable thruster assemblies 110 to provide the majority of the aircraft lift.

In an embodiment, as shown in FIGS. 1 and 2, a rotatable thruster aircraft 100 200 can include:
a) an airframe 135 235, which can include at least one fixed wing 140 240 and/or an aircraft body 220; and
b) at least one right rotatable thruster assembly 212, comprising:
   a right rotatable structure 242, which is rotatably connected to the airframe 135 235, such as the fixed wing 140 240, on a right side of a longitudinal axis 250 of the rotatable thruster aircraft 100 200 that intersects with a center of mass 258 of the rotatable thruster aircraft 100 200;
   at least one right thruster 232, which is connected to the right rotatable structure 242, such that the at least one right thruster 232 is offset from an axis of rotation 282 of the right rotatable structure 242;
   such that the at least one right rotatable thruster assembly 212 is rotatable from a right first position 292 providing a first downward vertical thrust 152 to a right second position 294 providing a first rearward horizontal thrust 154; and
c) at least one left rotatable thruster assembly 214, comprising:
   a left rotatable structure 244, which is rotatably connected to the fixed wing 140 240 on a left side of a longitudinal axis 250 of the rotatable thruster aircraft; and
   at least one left thruster 236, which is connected to the left rotatable structure 244, such that the at least one left thruster 234 is offset from an axis of rotation 264 of the at least one left rotatable structure;
   such that the at least one left rotatable thruster assembly 214 is rotatable from a left first position 292 providing a second downward vertical thrust 152 to a left second position 294 providing a second rearward horizontal thrust 154.

In a related embodiment, as shown in FIGS. 1 and 2, the at least one right thruster 232 can include:
a first right thruster 232, which is connected to the right rotatable structure 242 on a first side of the axis of rotation 262 of the right rotatable structure 212; and
a second right thruster 234, which is connected to the right rotatable structure 242 on a second side of the axis of rotation 262 of the right rotatable structure 212;
such that the first and second right thrusters 232 234 are opposedly connected to the right rotatable structure 242 with respect to the axis of rotation 262 of the right rotatable structure 212;
such that the at least one right rotatable thruster assembly 212 is rotatable via application of a first differential thrust of the first and second right thrusters 232 234;
such that increased differential thrust of the first right thruster 232 relative to the second right thruster 234, causes a rotation toward the right first position 292 (only the left rotatable thruster assembly 214 is shown in the first position);
such that increased differential thrust of the second right thruster 234 relative to the first right thruster 232, causes a rotation toward the right second position 294 (only the right rotatable thruster assembly 212 is shown in the second position); and

wherein the at least one left thruster 234 comprises:
a first left thruster 236, which is connected to the left rotatable structure 244 on a first side of the axis of rotation 264 of the left rotatable structure 244; and
a second left thruster 238, which is connected to the left rotatable structure 244 on a second side of the axis of rotation 264 of the left rotatable structure 244;
such that the first and second left thrusters 236 238 are opposedly connected to the left rotatable structure 244 with respect to the axis of rotation 264 of the left rotatable structure 244;
such that the at least one left rotatable thruster assembly 214 is rotatable via application of a second differential thrust of the first and second left thrusters 236 238;
such that increased differential thrust of the first left thruster 236 relative to the second left thruster 238, causes a rotation toward the left first position 292;
such that increased differential thrust of the second left thruster 238 relative to the first left thruster 236, causes a rotation toward the left second position 294.

In another related embodiment, as shown in FIGS. 1 and 2, the at least one right rotatable thruster assembly 212 can be connected to a right tip of the at least one fixed wing 140 240, and the at least one left rotatable thruster assembly 214 can be connected to a left tip of the at least one fixed wing 140 240.

In yet another related embodiment, as shown in FIG. 14:
the at least one right rotatable thruster assembly 1412 can be connected along a span of the at least one fixed wing 1240, such that an outer right end 1242 of the at least one fixed wing 1240 extends beyond the at least one right rotatable thruster assembly 1412; and
the at least one left rotatable thruster assembly 1414 can be connected along the span of the at least one fixed wing 1240, such that an outer left end 1242 of the at least one fixed wing 1240 extends beyond the at least one left rotatable thruster assembly 1414.

In another related embodiment, as shown in FIG. 2A:
a) the at least one right rotatable thruster assembly 212 can further include a right rotatable winglet 272, which is connected to the right rotatable structure 242, such that the right rotatable winglet 272 is configured to rotate with the right rotatable structure 242;
   such that the right rotatable winglet 272 is perpendicular to a forward direction of the rotatable thruster aircraft 200 when the at least one right rotatable thruster assembly 212 is in the right first position 292, whereby the right rotatable winglet is configured to function as an airbrake;
   such that the right rotatable winglet 272 is parallel to a forward direction of the rotatable thruster aircraft 200 when the at least one right rotatable thruster assembly 212 is in the right second position 294, whereby the right rotatable winglet 272 is configured to provide minimal drag; and
b) the at least one left rotatable thruster assembly 214 further comprises a left rotatable winglet 274, which is connected to the left rotatable structure 244, such that the left rotatable winglet 274 is configured to rotate with the left rotatable structure 244;
   such that the left rotatable winglet 274 is perpendicular to the forward direction of the rotatable thruster aircraft 200 when the at least one left rotatable thruster assembly 214 is in the left first position, whereby the left rotatable winglet 274 is configured to function as an airbrake;
   such that the left rotatable winglet 274 is parallel to a forward direction of the rotatable thruster aircraft 200 when the at least one left rotatable thruster assembly 214 is in the left second position, whereby the left rotatable winglet 274 is configured to provide minimal drag.

In yet a related embodiment, as shown in FIG. 12:
a) the at least one right rotatable thruster assembly 1212 can further include a right landing gear 1282, which is connected to the right rotatable structure 1242, such that the right landing gear 1282 is configured to rotate with the right rotatable structure 1242;
   such that the right landing gear 1282 protrudes downward from the rotatable thruster aircraft 1200 when the at least one right rotatable thruster assembly 1212 is in the right first position 1292, whereby the right landing gear is configured to contact with a ground 1288 below the rotatable thruster aircraft 1200, when the rotatable thruster aircraft is landing;
   such that the right landing gear 1282 protrudes rearward from the rotatable thruster aircraft when the at least one right rotatable thruster assembly 1212 is in the right second position 1294, whereby the right landing gear 1282 is configured to provide minimal drag during flight of the rotatable thruster aircraft 1200; and
b) the at least one left rotatable thruster assembly 1214 can further include a left landing gear 1284, which is connected to the left rotatable structure 1244, such that the left landing gear 1284 is configured to rotate with the left rotatable structure 1244;
   such that the left landing gear 1284 protrudes downward from the rotatable thruster aircraft when the at least one left rotatable thruster assembly 1214 is in the left first position 1292, whereby the left landing gear 1284 is configured to contact with the ground below the rotatable thruster aircraft, when the rotatable thruster aircraft is landing;
   such that the left landing gear 1284 protrudes rearward from the rotatable thruster aircraft when the at least one left rotatable thruster assembly 1214 is in the left second position 1294 (only the right rotatable thruster assembly 1214 is shown in the second position 1294), whereby the left landing gear 1284 is configured to provide minimal drag during flight of the rotatable thruster aircraft 1200.

In another related embodiment, as shown in FIG. 3, the rotatable thruster aircraft 300 can further include a first vertical lift thruster 366 and a second vertical lift thruster 368 that are each connected to a wing 140, fuselage 140, or aircraft body 140 of the rotatable thruster aircraft 300;

such that the first vertical lift thruster is positioned forward of a lateral axis 355 through a center of mass 358 of the rotatable thruster aircraft 300; and
such that the second vertical lift thruster 368 is positioned rearward of the lateral axis 355 through the center of mass 358 of the rotatable thruster aircraft 500;
such that the first and second vertical lift thrusters 366 368 are configured to provide pitch 382 control of the rotatable thruster aircraft 300, by application of a differential thrust between the first and second vertical lift thrusters 366 368.

In yet another related embodiment, as shown in FIG. 5, the rotatable thruster aircraft 500 can further include a first vertical lift thruster 566 and a second vertical lift thruster 576 that are each connected to a wing 540, fuselage 540, or aircraft body 540;

such that the first vertical lift thruster 566 is positioned rightward of a longitudinal axis 550 through a center of mass 558 of the rotatable thruster aircraft 500; and
such that the second vertical lift thruster 576 is positioned leftward of the longitudinal axis 550 through the center of mass 558 of the rotatable thruster aircraft 500;
such that the first and second vertical lift thrusters 566 576 are configured to provide roll control of the rotatable thruster aircraft, by application of a differential thrust between the first and second vertical lift thrusters.

In another related embodiment, as shown in FIG. 3, the rotatable thruster aircraft 300 can further include at least one linear thruster array 360, connected to a wing 340, fuselage 340, or aircraft body 340, the at least one linear thruster array 360 comprising a first vertical lift thruster 366 and a second vertical lift thruster 368, which are both configured to provide a fixed downward vertical thrust, such that the at least one linear thruster array 360 is parallel to a longitudinal axis 350 of the rotatable thruster aircraft 300, such that the first vertical lift thruster 366 is positioned on a front side with respect to a lateral line/axis 355 through a center of mass 358 of the rotatable thruster aircraft 300; and such that the second vertical lift thruster 368 is positioned on a rear side with respect to the lateral line/axis 355 through the center of mass 358 of the rotatable thruster aircraft 300.

In another related embodiment, as shown in FIG. 3, the at least one linear thruster array 360 can further include an elongated member/boom 322, such that the first and second vertical lift thrusters 366 368 are connected to the elongated member 322.

In another related embodiment, as shown in FIG. 5, a rotatable thruster aircraft 500 can further include a configuration wherein the at least one linear thruster array 360 comprises:
a) a first linear thruster array 462; and
b) a second linear thruster array 464;
wherein the first and second linear thruster arrays 462 464 are positioned on opposing lateral sides of the longitudinal axis 550.

In a further related embodiment, as shown in FIG. 13, a rotatable thruster aircraft 1300 can further include a configuration wherein the at least one linear thruster array 360 further comprises a third linear thruster array 1360, which is positioned along the longitudinal axis 1350.

In a further related embodiment, as shown in FIG. 9, a rotatable thruster aircraft 900 can further include a configuration wherein the at least one linear thruster 960 array can include a first vertical lift thruster assembly 962 and a second vertical lift thruster assembly 966;

such that the at least one linear thruster array 960 is parallel to a longitudinal axis 950 of the rotatable thruster aircraft 900;
such that the first vertical lift thruster assembly 962 is positioned on a front side with respect to a lateral line 955 through a center of mass 958 of the rotatable thruster aircraft 900; and
such that the second vertical lift thruster assembly 962 is positioned on a rear side with respect to the lateral line 955 through the center of mass 958 of the rotatable thruster aircraft 900;
wherein the first vertical lift thruster assembly 962 comprises a first top thruster 963 and a first bottom thruster 964, such that the first top and bottom thrusters 963 964 are stacked vertically, such that the first top thruster 963 is positioned on top of the first bottom thruster 964;
wherein the second vertical lift thruster assembly 966 comprises a second top thruster 967 and a second bottom thruster 968, such that the second top and bottom thrusters 967 968 are stacked vertically, such that the second top thruster 967 is positioned on top of the second bottom thruster 968.

In a further related embodiment, as shown in FIG. 21,

the at least one right thruster 112 can further include:
a right central thruster 2113, which is connected to the right rotatable structure at a position of a right axis of rotation 2180, between the first and second right thrusters 2112 2114; and

the at least one left thruster 112 further comprises:
a left central thruster 2113, which is connected to the left rotatable structure at a position of a left axis of rotation 2180, between the first and second left thrusters 2112 2114.

In another related embodiment, each thruster 112 of the right and left rotatable thruster assemblies 110 can be a rotor.

In a further related embodiment, as shown in FIG. 24, a rotatable thruster aircraft 2400 can further include a plurality of rotor shrouds 2419, wherein each thruster 2416 of the right and left rotatable thruster assemblies 2412 2414 can be configured to spin inside a rotor shroud 2419. The thrusters can for example be rotors or turbines. Similarly, the vertical thrusters 2460 can be configured to spin inside a rotor shroud 2469.

In a related embodiment, as shown in FIG. 27, a rotatable thruster aircraft 2700 can further include an aircraft control unit 842, which can be mounted in the aircraft fuselage/body 2720, wherein the aircraft control unit 842 can be configured to control a specific power applied for each thruster in the right and left rotatable thruster assemblies 2712 2714 and for each thruster in the vertical thruster assemblies 2760.

In an embodiment, as shown in FIGS. 1 and 2A, 2B, and 2C, a rotatable thruster aircraft 100 200 can include:

a) an aircraft fuselage 140 (or aircraft body/central structure 140); and

b) at least one right rotatable thruster assembly 212, including:
a right rotatable structure 242, which is rotatably connected to the fixed wing 140 240 on a right side of a longitudinal axis 250 of the rotatable thruster aircraft 100 200; and
at least one right thruster 232, which is connected to the right rotatable structure 242, such that the at least one right thruster 232 is offset from an axis of rotation 262 of the right rotatable structure 242;
such that the at least one right rotatable thruster assembly 212 is rotatable from a right first position 292 providing a first downward vertical thrust 152 to a right second position 294 providing a first rearward horizontal thrust 154; and

c) at least one left rotatable thruster assembly 214, including:
a left rotatable structure 244, which is rotatably connected to the fixed wing 140 240 on a left side of a longitudinal axis 250 of the rotatable thruster aircraft; and
at least one left thruster 234, which is connected to the left rotatable structure 244, such that the at least one left thruster 234 is offset from an axis of rotation 264 of the at least one left rotatable structure;
such that the at least one left rotatable thruster assembly 214 is rotatable from a left first position 292 providing a second downward vertical thrust 152 to a left second position 294 providing a second rearward horizontal thrust 154.

FIGS. 28 and 29 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 28 and 29 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

It shall be understood that the above-mentioned components of the aircraft control unit 842 are to be interpreted in the most general manner.

For example, the processor 2902 can include a single physical microprocessor or microcontroller, a cluster of processors, a datacenter or a cluster of datacenters, a computing cloud service, and the like.

In a further example, the non-transitory memory 2904 can include various forms of non-transitory storage media, including random access memory and other forms of dynamic storage, and hard disks, hard disk clusters, cloud storage services, and other forms of long-term storage. Similarly, the input/output 2906 can include a plurality of well-known input/output devices, such as screens, keyboards, pointing devices, motion trackers, communication ports, and so forth.

Furthermore, it shall be understood that the aircraft control unit 842 can include a number of other components that are well known in the art of general computer devices, and therefore shall not be further described herein. This can include system access to common functions and hardware, such as for example via operating system layers such as WINDOWS™, LINUX™, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the rotatable thruster aircraft 100, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A rotatable thruster aircraft, comprising:
a) an airframe; and
b) at least one right rotatable thruster assembly, comprising:
a right rotatable structure, which is rotatably connected to the airframe on a right side of a longitudinal axis of the rotatable thruster aircraft that intersects with a center of mass of the rotatable thruster aircraft;
a first right thruster, which is connected to the right rotatable structure on a first side of an axis of rotation of the right rotatable structure; and
a second right thruster, which is connected to the right rotatable structure on a second side of the axis of rotation of the right rotatable structure;
such that the at least one right rotatable thruster assembly is rotatable via application of a first differential thrust of the first and second right thrusters;
such that the at least one right rotatable thruster assembly is rotatable from a right first position providing a first downward vertical thrust to a right second position providing a first rearward horizontal thrust; and
c) at least one left rotatable thruster assembly, comprising:
a left rotatable structure, which is rotatably connected to the airframe on a left side of the longitudinal axis of the rotatable thruster aircraft;
a first left thruster, which is connected to the left rotatable structure on a first side of an axis of rotation of the left rotatable structure; and
a second left thruster, which is connected to the left rotatable structure on a second side of the axis of rotation of the left rotatable structure;
such that the at least one left rotatable thruster assembly is rotatable via application of a second differential thrust of the first and second left thrusters;
such that the at least one left rotatable thruster assembly is rotatable from a left first position providing a second downward vertical thrust to a left second position providing a second rearward horizontal thrust.

2. The rotatable thruster aircraft of claim 1, wherein the airframe further comprises at least one fixed wing, such that the right and left rotatable structures each are rotatably connected to the at least one fixed wing.

3. The rotatable thruster aircraft of claim 2, wherein the at least one right rotatable thruster assembly is connected to a right tip of the at least one fixed wing, and the at least one left rotatable thruster assembly is connected to a left tip of the at least one fixed wing.

4. The rotatable thruster aircraft of claim 2, wherein:
the at least one right rotatable thruster assembly is connected along a span of the at least one fixed wing, such that an outer right end of the at least one fixed wing extends beyond the at least one right rotatable thruster assembly; and
the at least one left rotatable thruster assembly is connected along the span of the at least one fixed wing, such that an outer left end of the at least one fixed wing extends beyond the at least one left rotatable thruster assembly.

5. The rotatable thruster aircraft of claim 1, wherein:
a) the at least one right rotatable thruster assembly further comprises a right rotatable winglet, which is connected to the right rotatable structure, such that the right rotatable winglet is configured to rotate with the right rotatable structure;
such that the right rotatable winglet is perpendicular to a forward direction of the rotatable thruster aircraft when the at least one right rotatable thruster assembly is in the right first position, whereby the right rotatable winglet is configured to function as an airbrake;
such that the right rotatable winglet is parallel to a forward direction of the rotatable thruster aircraft when the at least one right rotatable thruster assembly is in the right second position, whereby the right rotatable winglet is configured to provide minimal drag; and
b) the at least one left rotatable thruster assembly further comprises a left rotatable winglet, which is connected to the left rotatable structure, such that the left rotatable winglet is configured to rotate with the left rotatable structure;
such that the left rotatable winglet is perpendicular to the forward direction of the rotatable thruster aircraft when the at least one left rotatable thruster assembly is in the left first position, whereby the left rotatable winglet is configured to function as an airbrake;
such that the left rotatable winglet is parallel to a forward direction of the rotatable thruster aircraft when the at least one left rotatable thruster assembly is in the left second position, whereby the left rotatable winglet is configured to provide minimal drag.

6. The rotatable thruster aircraft of claim 1, wherein:
a) the at least one right rotatable thruster assembly further comprises a right landing gear, which is connected to the right rotatable structure, such that the right landing gear is configured to rotate with the right rotatable structure;
such that the right landing gear protrudes downward from the rotatable thruster aircraft when the at least one right rotatable thruster assembly is in the right first position, whereby the right landing gear is configured to contact with a ground below the rotatable thruster aircraft, when the rotatable thruster aircraft is landing;
such that the right landing gear protrudes rearward from the rotatable thruster aircraft when the at least one right rotatable thruster assembly is in the right second position, whereby the right landing gear is configured to provide minimal drag during flight of the rotatable thruster aircraft; and
b) the at least one left rotatable thruster assembly further comprises a left landing gear, which is connected to the left rotatable structure, such that the left landing gear is configured to rotate with the left rotatable structure;
such that the left landing gear protrudes downward from the rotatable thruster aircraft when the at least one left rotatable thruster assembly is in the left first position, whereby the left landing gear is configured to contact with the ground below the rotatable thruster aircraft, when the rotatable thruster aircraft is landing;
such that the left landing gear protrudes rearward from the rotatable thruster aircraft when the at least one left rotatable thruster assembly is in the left second position, whereby the left landing gear is configured to provide minimal drag during flight of the rotatable thruster aircraft.

7. The rotatable thruster aircraft of claim 1, further comprising a first vertical lift thruster and a second vertical lift thruster;
such that the first vertical lift thruster is positioned forward of a lateral axis through a center of mass of the rotatable thruster aircraft; and
such that the second vertical lift thruster is positioned rearward of the lateral axis through the center of mass of the rotatable thruster aircraft;
such that the first and second vertical lift thrusters are configured to provide pitch control of the rotatable thruster aircraft, by application of a differential thrust between the first and second vertical lift thrusters.

8. The rotatable thruster aircraft of claim 1, further comprising a first vertical lift thruster and a second vertical lift thruster;
such that the first vertical lift thruster is positioned rightward of a longitudinal axis through a center of mass of the rotatable thruster aircraft; and
such that the second vertical lift thruster is positioned leftward of the longitudinal axis through the center of mass of the rotatable thruster aircraft;
such that the first and second vertical lift thrusters are configured to provide roll control of the rotatable thruster aircraft, by application of a differential thrust between the first and second vertical lift thrusters.

9. The rotatable thruster aircraft of claim 1, further comprising at least one linear thruster array comprising a first vertical lift thruster and a second vertical lift thruster, such that the at least one linear thruster array is parallel to a longitudinal axis of the rotatable thruster aircraft, such that the first vertical lift thruster is positioned on a front side with respect to a lateral line through a center of mass of the rotatable thruster aircraft; and such that the second vertical lift thruster is positioned on a rear side with respect to the lateral line through the center of mass of the rotatable thruster aircraft.

10. The rotatable thruster aircraft of claim 9, wherein the at least one linear thruster array further comprises an elongated member, such that the first and second vertical lift thrusters are connected to the elongated member.

11. The rotatable thruster aircraft of claim 9, wherein the at least one linear thruster array comprises:
a) a first linear thruster array; and
b) a second linear thruster array;
wherein the first and second linear thruster arrays are positioned on opposing lateral sides of the longitudinal axis.

12. The rotatable thruster aircraft of claim 11, wherein the at least one linear thruster array further comprises a third linear thruster array, which is positioned along the longitudinal axis.

13. The rotatable thruster aircraft of claim 1, further comprising at least one linear thruster array comprising a first vertical lift thruster assembly and a second vertical lift thruster assembly;
such that the at least one linear thruster array is parallel to a longitudinal axis of the rotatable thruster aircraft, such that the first vertical lift thruster assembly is positioned on a front side with respect to a lateral line through a center of mass of the rotatable thruster aircraft; and
such that the second vertical lift thruster assembly is positioned on a rear side with respect to the lateral line through the center of mass of the rotatable thruster aircraft;
wherein the first vertical lift thruster assembly comprises a first top thruster and a first bottom thruster, such that the first top and bottom thrusters are stacked vertically, such that the first top thruster is positioned on top of the first bottom thruster;
wherein the second vertical lift thruster assembly comprises a second top thruster and a second bottom thruster, such that the second top and bottom thrusters are stacked vertically, such that the second top thruster is positioned on top of the second bottom thruster.

14. The rotatable thruster aircraft of claim 1, wherein:
the at least one right rotatable thruster assembly further comprises:
a right central thruster, which is connected to the right rotatable structure at a position of a right axis of rotation, between the first and second right thrusters; and
the at least one left rotatable thruster assembly further comprises:
a left central thruster, which is connected to the left rotatable structure at a position of a left axis of rotation, between the first and second left thrusters.

15. The rotatable thruster aircraft of claim 1, wherein each thruster of the right and left rotatable thruster assemblies is a rotor.

16. The rotatable thruster aircraft of claim 1, further comprising a plurality of rotor shrouds, wherein each thruster of the right and left rotatable thruster assemblies is configured to spin inside a rotor shroud.

17. The rotatable thruster aircraft of claim 1, further comprising an aircraft control unit, which is mounted in the aircraft body, wherein the aircraft control unit is configured to control a specific power applied for each thruster in the right and left rotatable thruster assemblies.

18. The rotatable thruster aircraft of claim 17, wherein the aircraft control unit further comprises:
a) a processor;
b) a non-transitory memory;
c) an input/output component; and
d) a power manager, which is configured to control the specific power applied for each thruster in the right and left rotatable thruster assemblies; all connected via
e) a data bus.

19. The rotatable thruster aircraft of claim 1, further comprising at least one unpowered rotor, which is configured to rotate and provide lift during forward flight, such that the rotatable thruster aircraft is configured as an autogyro.

20. The rotatable thruster aircraft of claim 1, wherein:
a) the at least one right rotatable thruster assembly further comprises:
a right forward rotational stop member, which is configured to stop a forward rotation of the at least one right rotatable thruster assembly at a right maximum forward rotation position; and
a right rearward rotational stop member, which is configured to stop a rearward rotation of the at least one right rotatable thruster assembly at a right maximum rearward rotation position; and
b) the at least one left rotatable thruster assembly further comprises:
a left forward rotational stop member, which is configured to stop a forward rotation of the at least one left rotatable thruster assembly at a left maximum forward rotation position; and
a left rearward rotational stop member, which is configured to stop a rearward rotation of the at least one left rotatable thruster assembly at a left maximum rearward rotation position.

21. The rotatable thruster aircraft of claim 17, wherein the rotatable thruster aircraft is configured with solely the right and left rotatable thruster assemblies, wherein the aircraft control unit is mounted on a main body of the airframe, such that the aircraft control unit is configured to determine and control the position of the main body and positions and thrust outputs of the right and left rotatable thruster assemblies in relation to the main body during vertical flight, such that:
a) a movement around a yaw axis of the main body indicates positions of the right and left rotatable thruster assemblies relative to each other, such that a right yaw indicates that the left rotatable thruster assembly is pitched forward relative to the right rotatable thruster assembly, and a left yaw indicates that the right rotatable thruster assembly is pitched forward relative to the left rotatable thruster assembly;
b) a movement around a roll axis of the main body indicates thrust outputs of the right and left rotatable thruster assemblies relative to each other, such that a right roll indicates that the left rotatable thruster assembly is producing more thrust relative to the right rotatable thruster assembly, and a left roll indicates that the right rotatable thruster assembly is producing more thrust relative to the left rotatable thruster assembly; and
c) a movement along a longitudinal axis of the main body indicates positions of the right and left rotatable thruster assemblies in relation to the main body, such that a forward motion along the longitudinal axis of the main body indicates that the rotatable thruster assemblies are pitched forward in relation to the main body, and a rearward motion along the longitudinal axis of the main body indicates that the rotatable thruster assemblies are pitched rearward in relation to the main body.

22. The rotatable thruster aircraft of claim 17, wherein the rotatable thruster aircraft is be configured with solely the right and left rotatable thruster assemblies, wherein the aircraft control unit is mounted on a main body of the airframe, such that the aircraft control unit is configured to determine and control the position of the main body and positions and thrust outputs of the right and left rotatable thruster assemblies in relation to the main body during horizontal flight, such that:
a) a movement around a yaw axis of the main body indicates thrust outputs of the right and left rotatable thruster assemblies relative to each other, such that a right yaw indicates that the left rotatable thruster assembly is producing more thrust relative to the right rotatable thruster assembly, and a left yaw indicates that the right rotatable thruster assembly is producing more thrust relative to the left rotatable thruster assembly;
b) a movement around a roll axis of the main body indicates positions of the right and left rotatable thruster assemblies relative to each other, such that a right roll of the main body indicates that the right rotatable thruster assembly is pitched forward relative to the left rotatable thruster assembly, and a left roll of the main body indicates that the left rotatable thruster assembly is pitched forward relative to the right rotatable thruster assembly; and
c) a movement around a pitch axis of the main body indicates pitch of the right and left rotatable thruster assemblies, such that an upward pitch of the main body indicates that the rotatable thruster assemblies are pitched rearward in relation to the main body, and a downward pitch of the main body indicates that the rotatable thruster assemblies are pitched forward in relation to the main body.

23. The rotatable thruster aircraft of claim 1, wherein the right rotatable thruster assembly is configured with a right center of mass that is offset from the axis of rotation of the right rotatable thruster assembly, such that the right rotatable thruster assembly is configured to be in a vertical take-off position, when the right rotatable thruster assembly is rotated by gravity to a right position with the right center of mass in a lowest position; and
wherein the left rotatable thruster assembly is configured with a left center of mass that is offset from the axis of rotation of the left rotatable thruster assembly, such that the left rotatable thruster assembly is configured to be in a vertical take-off position, when the right rotatable thruster assembly is rotated by gravity to a left position with the left center of mass in a lowest position.
